(19) United States
(12) Patent Application Publication
(10) Pub. No.: US 2023/0035913 A1
(43) Pub. Date: Feb. 2, 2023

(54) NITRAPYRIN COMPOSITIONS FOR ENHANCING NITROGEN NUTRIENT USE EFFICIENCY AND IMPROVING PLANT GROWTH

(71) Applicant: Verdesian Life Sciences U.S., LLC, Cary, NC (US)

(72) Inventors: Ashish Arun PANDYA, Morrisville, NC (US); Kuide QIN, Chapel Hill, NC (US); Gary ORR, Pittsboro, NC (US)

(21) Appl. No.: 17/790,805

(22) PCT Filed: Jan. 4, 2021
(86) PCT No.: PCT/US2021/012084

§ 371 Date: Jul. 5, 2022

Related U.S. Application Data
(60) Provisional application No. 62/957,853, filed on Jan. 7, 2020.

(51) Int. Cl. A01N 37/02; A01N 43/40; C05G 3/90

(52) U.S. Cl. CPC A01N 37/02; A01N 43/40; C05G 3/90

(57) ABSTRACT

The presently disclosed subject matter is directed to nitrapyrin complexes and mixtures as well as syntheses thereof finding particular utility in agricultural uses. For example, these complexes or mixtures can be directly applied to soil, or can be applied in combination with fertilizers to increase nutrient uptake and to inhibit nitrification and urease hydrolysis. More particularly, the subject matter is directed to nitrapyrin complexed or mixed with monoacids that can be further functionalized. Other uses of the nitrapyrin complexes and mixtures, and compositions containing the nitrapyrin complexes and mixtures are disclosed.

### FIELD

The presently disclosed subject matter is directed to nitrapyrin complexes and mixtures with monoacids selected from monocarboxylic acids, monosulfonic acids, and monophosphonic acids, and syntheses thereof finding particular utility in agricultural uses to increase nutrient uptake and to inhibit nitrification.

### BACKGROUND

Nitrogen fertilizer added to the soil is readily transformed through a number of biological and chemical processes, including nitrification, leaching, and evaporation. Many transformation processes are undesirable because they reduce the level of nitrogen available for uptake by the targeted plant. The decrease in available nitrogen requires the addition of more nitrogen-rich fertilizer to compensate for the loss of agriculturally active nitrogen available to the plants. Nitrification is the process by which certain widely occurring soil bacteria metabolize the ammonium form of nitrogen in the soil transforming the nitrogen into nitrite and nitrate forms, which are more susceptible to nitrogen loss through leaching or volatilization via denitrification. These concerns require improved management of nitrogen for economic efficiency and protection of the environment.

Nitrogen nutrient use efficiency enhancing compounds attempt to reduce nitrification. These so-called nitrification inhibitors have been developed to inhibit nitrogen loss due to nitrification. One class of nitrification inhibitors in use is composed of various chlorinated compounds related to pyridine, as taught by Goring in US 3,135,594 (incorporated herein in its entirety by reference). Nitrapyrin is an example of a nitrification inhibitor.

Current formulations consist of nitrapyrin dissolved in large volumes of volatile, flammable, toxicologically problematic, environmentally problematic, and/or highly odoriferous aromatic solvents (e.g., toluene, xylenes, etc.). For every unit weight of nitrapyrin delivered to the field, more than 3-4 unit weights of such solvents are also delivered to the same soil. The relatively low concentration of active ingredient contributes to increased shipping costs, increased difficulty of handling, and reduced efficiency. Furthermore, once nitrapyrin has been employed, it suffers from significant losses to the atmosphere, resulting in undesirable environmental effects, loss of efficacy of product by way of potency loss, and offensive odors. It is desirable to find a way to depress nitrapyrin volatilization without resorting to costly techniques. Further, is it desirable to replace current products with formulations that are more economical, less toxic, and less harmful to the environment.

### BRIEF SUMMARY

In one aspect, the subject matter described herein is directed to nitrapyrin complexes or mixtures with monoacid(s), various uses of the nitrapyrin complexes or mixtures, alone or in conjunction with other compounds. The monoacid(s) can be a monocarboxylic acid, a monosulfonic acid or a monophosphonic acid. In some embodiments, the monoacid is substituted with an alkyl group, an alkenyl group, or an aromatic ring system.

In one aspect, the subject matter described herein is directed to a composition comprising an agricultural product and nitrapyrin complexed or mixed with a monoacid.

In one aspect, the subject matter described herein is directed to a composition comprising nitrapyrin complexed or mixed with a monoacid, and an organic solvent, wherein the concentration of nitrapyrin is above about 20% wt/wt.

In some embodiments, the disclosed nitrapyrin complex or mixture exhibits decreased volatilization in appropriate solvents when compared to nitrapyrin alone dissolved in solvent or when compared to known commercial nitrapyrin formulations.

In some embodiments, the subject matter described herein is directed to formulations suitable for use in agriculture, where the formulations comprise a described nitrapyrin-monoacid complex or mixture.

In some embodiments, the subject matter described herein is directed to methods of increasing plant growth, yields and health, by contacting a composition comprising a described nitrapyrin-monoacid complex or mixture with the plant or soil in the area of the plant.

In some embodiments, the subject matter described herein is directed to methods of decreasing nitrification and/or reducing atmospheric ammonia.

In some embodiments, the subject matter described herein is directed to methods of preparing the disclosed nitrapyrin-monoacid complexes or mixtures and compositions and formulations containing nitrapyrin-monoacid complex or mixture.

These and other aspects are fully described below.

### BRIEF DESCRIPTION OF THE DRAWINGS

FIG. 1 shows a picture of five vials containing nitrapyrin with and without a monoacid dissolved in Rhodiasolv® Polarclean. The content and physical properties of the vials are as follows: Vial 1 nitrapyrin, colorless; Vial 2 nitrapyrin and 2,5-dihydroxybenzoic acid, light yellow in color; Vial 3 nitrapyrin and 2,4-dihydroxybenzoic acid, yellow/orange in color; and Vial 4 nitrapyrin and 3,4-dihydroxybenzoic acid, greenish/grey in color.

FIG. 2 shows a picture of three vials containing nitrapyrin with and without a monoacid dissolved in Rhodiasolv® Polarclean. The content and physical properties of the vials are as follows: Vial 1 nitrapyrin, colorless; Vial 2 nitrapyrin and methanesulfonic acid, colorless; and Vial 3 nitrapyrin and 2,4-dihydroxybenzoic acid, yellow/orange in color.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Advantageously, the compositions and methods described herein have been shown to provide desirable properties for the use of nitrapyrin in agriculture by formulating nitrapyrin complexes or mixtures with monoacids selected from substituted/unsubstituted monocarboxylic acids, substituted/unsubstituted monosulfonic acids, and substituted/unsubstituted monophosphonic acids. Substituted monoacids can include an alkyl group, an alkenyl group, or an aromatic ring system. Desirable properties of such acids include, but are not limited to: low cost, higher actives content relative to marketed products, ease of preparation, excellent environmental and toxicology profiles, and nonliquid dosage forms. As disclosed herein, among other properties, the nitrapyrin-monoacid complexes/mixtures have significantly lower vapor pressure, thereby reducing volatilization; increased solubility, thereby providing compositions with high loading and/or concentration; and increased stability when formulated in an environment with reduced water content.

Heretofore, methods found in the art for reducing volatility of materials involving pyridine derivatives involved an opposite approach. For example, the use of poly(4-vinylpyridine) sulfur trioxide complex is known to the art of sulfonation chemistry, wherein the volatility of sulfur trioxide is controlled by formation of a complex with poly(4-vinylpyridine). In this example, the pyridine derivative part of the molecule is the nonvolatile portion, whereas the sulfur trioxide is the volatile portion. By contrast, a distinctly different approach as described herein utilizes nitrapyrin-monoacid complexes with one or more monoacid(s) selected from monocarboxylic acids, monosulfonic acids, and monophosphonic acids as a nonvolatile component and a pyridine derivative, such as nitrapyrin as a volatile component.

### I. Definitions

As used herein, the term “complex” or “complex substance” refers to chelates, coordination complexes, charge transfer complexes, and salts of nitrapyrin, wherein nitrapyrin associates with the acidic functional group of the monoacid(s) (e.g., -COOH, —SO₃H, —PO₃H₂) in a covalent (i.e., bond forming) or noncovalent (i.e., ionic) manner. In some cases nitrapyrin associates with the entire molecule. In a complex, a central moiety or ion (e.g., nitrapyrin) associates with a surrounding array of bound molecules or ions known as ligands or complexing agents (e.g., monoacid(s)). The central moiety binds to or associates with several donor atoms of the ligand, wherein each donor atom is a different atom but is the same type of atom (e.g., oxygen (O)). Ligands or complexing agents bound to the central moiety through several of the ligand’s donor atoms forming multiple bonds (i.e., 2, 3, 4 or even 6 bonds) is referred to as a polydentate ligand. Complexes with polydentate ligands are called chelates. Typically, complexes of central moieties with ligands are increasingly more soluble than the central moiety by itself because the ligand(s) that surround(s) the central moiety do not dissociate from the central moiety once in solution and solvates the central moiety thereby promoting its solubility.

As used herein, the term “salt” refers to chemical compounds consisting of an assembly of cations and anions. Salts are composed of related numbers of cations (positively charged ions) and anions (negative ions) so that the product is electrically neutral (without a net charge). Many ionic compounds exhibit significant solubility in protic solvents such as water or other polar solvents. The solubility is dependent on how well each ion interacts with the solvent.

As used herein, the terms “charge-transfer complex (CT complex)” or “electron-donor-acceptor complex” are an association of two or more molecules, or of different parts of one large molecule, in which a fraction of electronic charge is transferred between the molecular entities. The resulting electrostatic attraction provides a stabilizing force for the molecular complex. The source molecule from which the charge is transferred is called the electron donor and the receiving species is called the electron acceptor. The nature of the attraction in a charge-transfer complex is not a stable chemical bond, and is thus much weaker than covalent forces.

As used herein, the term “monoacid” refers to a compound and/or ligand having a single acid functionality such as carboxylic acid (-COOH), phosphonic acid (—PO₃H₂ or —PO(OR₂), and/or sulfonic acid (-SO₃H) that associates with nitrapyrin in a covalent or noncovalent manner. The monoacid can be further functionalized to contain additional functional groups (e.g., hydroxyl, cycloalkyl, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, thiohaloalkyl, alkoxy, substituted alkoxy or haloalkoxy) even additional acid functional groups (e.g., -COOH, SO₃H, or PO₃H₂). However, these additional functional groups do not associate with the nitrapyrin in a covalent or noncovalent manner. Monoacids that are further functionalized may also be refered to as “polyfunctional” monoacids.

As used herein, the term “aromatic ring system” refers to ring systems that contain at least one heteroaryl ring and/or at least on aryl ring.

As used herein, the term “heteroaryl” refers to a radical that comprises at least a five-membered or six-membered unsaturated and conjugated aromatic ring containing at least two ring carbon atoms and 1 to 4 ring heteroatoms selected from nitrogen, oxygen and/or sulfur. Such heteroaryl radicals are often alternatively termed “heteroaromatic” by those of skill in the art. The heteroaryl radicals can have from two to twelve carbon atoms, or alternatively 4 to 5 carbon atoms in the heteroaryl ring. Examples include, but are not limited to, pyridinyl, pyrimidinyl, pyrazinyl, pyrrolyl, furanyl, tetrazolyl, isoxazolyl, oxadiazolyl, benzothiophenyl, benzofuranyl, quinolinyl, isoquinolinyl and the like.

As used herein, the term “aryl” refers to a radical comprising at least one unsaturated and conjugated six-membered ring analogous to the six-membered ring of benzene. Aryl radicals having such unsaturated and conjugated rings are also known to those of skill in the art as “aromatic” radicals. Preferred aryl radicals have 6 to 12 ring carbons. Aryl radicals include, but are not limited to, aromatic radicals comprising phenyl and naphthyl ring radicals.

As used herein, the term “substituted” refers to a moiety (such as heteroaryl, aryl, alkyl and/or alkenyl), wherein the moiety is bonded to one or more additional organic or inorganic substituent radicals. In some embodiments, the substituted moiety comprises 1, 2, 3, 4, or 5 additional substitutent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as heteroaryl, aryl, alkenyl and/or alkyl) that is not bonded to one or more additional organic or inorganic substituent radical as described above meaning that such a moiety is only substituted with hydrogens.

As used herein, the term “halo,” “halogen,” or “halide” refers to a fluoro, chloro, bromo or iodo atom or ion.

As used herein, the term “alkoxy” refers to an alkyl radical bound through a single, terminal ether linkage; that is, an “alkoxy” group can be defined as — OR where R is alkyl as defined above. Examples include, but are not limited to, methoxy, ethoxy, n-propoxy, iso-propoxy, n-butoxy, t-butoxy, iso-butoxy, sec-butoxy and the like.

As used herein, the term “substituted alkoxy” refers to an alkoxy radical as defined above having one, two, or more additional organic or inorganic substituent radicals bound to the alkyl radical. Suitable organic and inorganic substituent radicals include but are not limited to hydroxyl, cycloalkyl, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, thiohaloalkyl, alkoxy, substituted alkoxy or haloalkoxy. When the alkyl of the alkoxy is bonded thereon with more than one substituent radical, then the substituent radicals may be the same or different.

As used herein, the term “amino” refers to a substituted or unsubstituted trivalent nitrogen-containing radical or group that is structurally related to ammonia (NH₃) by the substitution of one or more of the hydrogen atoms of ammonia by a substitutent radical.

As used herein, the term “mono-substituted amino” refers to an amino substituted with one radical selected from alkyl, substituted alkyl or arylalkyl wherein the terms have the same definitions found herein.

As used herein, the term “di-substituted amino” refers to an amino substituted with two radicals that may be same or different selected from aryl, substituted aryl, alkyl, substituted alkyl or arylalkyl, wherein the terms have the same definitions as disclosed herein. Examples include, but are not limited to, dimethylamino, methylethylamino, diethylamino and the like. The two substituent radicals present may be the same or different.

As used herein, the term “haloalkyl” refers to an alkyl radical, as defined above, substituted with one or more halogens, such as flourine, chlorine, bromine, or iodine, preferably fluorine. Examples include but are not limited to trifluoromethyl, pentafluoroethyl and the like.

As used herein, the term “haloalkoxy” refers to a haloalkyl, as defined above, that is directly bonded to oxygen to form trifluoromethoxy, pentafluoroethoxy and the like.

As used herein, the term “acyl” denotes a radical containing a carbonyl (—C(O)—R group) wherein the R group is hydrogen or has 1 to 8 carbons. Examples include, but are not limited to, formyl, acetyl, propionyl, butanoyl, iso-butanoyl, pentanoyl, hexanoyl, heptanoyl, benzoyl and the like.

As used herein, the term “acyloxy” refers to a radical containing a carboxyl (—O— C(O)—R) group wherein the R group comprises hydrogen or 1 to 8 carbons. Examples include, but are not limited to, acetyloxy, propionyloxy, butanoyloxy, iso-butanoyloxy, benzoyloxy and the like.

As used herein, the term “alkyl group” refers a saturated hydrocarbon radical containing 1 to 8, 1 to 6, 1 to 4, or 5 to 8 carbons. An alkyl group is structurally similar to a noncyclic alkane compound modified by the removal of one hydrogen from the noncyclic alkane and the substitution therefore of a non-hydrogen group or radical. Alkyl group radicals can be branched or unbranched. Lower alkyl group radicals have 1 to 4 carbon atoms. Higher alkyl group radicals have 5 to 8 carbon atoms. Examples of alkyl, lower alkyl and higher alkyl group radicals include, but are not limited to, methyl, ethyl, n-propyl, iso-propyl, n-butyl, sec-butyl, t-butyl, amyl, t-amyl, n-pentyl, n-hexyl, i-octyl and like radicals.

As used herein, the term “alkenyl group” refers an unsaturated hydrocarbon radical containing 1 to 8, 1 to 6, 1 to 4, or 5 to 8 carbons and at least one carbon-carbon double bond. The unsaturated hydrocarbon radical is similar to an alkyl radical as defined above that also comprises at least one carbon-carbon double bond. Examples include, but are not limited to, vinyl, allyl, 2-butenyl, 3-butenyl, 2-pentenyl, 3-pentenyl, 4-pentenyl, 2-hexenyl, 3-hexenyl, 4-hexenyl, 5-hexanyl, 2-heptenyl, 3-heptenyl, 4-heptenyl, 5-heptenyl, 6-heptenyl and the like. The term “alkenyl” includes dienes and trienes of straight and branch chains.

As used herein, the term “sulfuric acid” is to be understood as being a mineral acid composed of the elements sulfur, oxygen, and hydrogen, with molecular formula H₂SO₄. Sulfuric acid is a member of the sulfonic acids.

As used herein, the term “sulfonic acid” refers to a member of the class of organosulfur compounds with the general formula R-S(=O)₂-OH, where R is a hydrogen, alkyl, alkenyl, or an aromatic ring system.

As used herein, the term “phosphoric acid” also known as orthophosphoric acids or phosphoric (V) acid refers to an acid with the chemical formula H₃PO₄. Phosphoric acid is a member of the phosphonic acids.

As used herein, the term “phosphonic acid” refers to a member of the class of organophosphorus compounds containing the general formulae R₁-PO(OH)₂ or R₁-PO(OR₂)₂ groups, where R₁ is a hydrogen, alkyl, alkenyl, hydroxyl, or an aromatic system and R₂ is H, alkyl, alkenyl, or an aromatic system.

As used herein, the term “carboxylic acid” refers to a member of the class of compounds with the general formula R-COOH, where R is hydrogen, alkyl, alkenyl, or an aromatic system.

As used herein, the prefix “mono” is understood to mean “single” or “one.” For example, the term “monocarboxylic acid” is understood to mean compounds that only contain a single carboxylic acid that associates with the nitrapyrin molecule. The monocarboxylic acid can optionally contain a second carboxylic acid group (-COOH group), however, this second carboxylic acid group does not associate with the nitrapyrin molecule. The same understanding is applied to terms such as “monosulfonic acids”, and “monophosphonic acids.”

As used herein, the term “soil” is to be understood as a natural body comprised of living (e.g., microorganisms (such as bacteria and fungi), animals and plants) and nonliving matter (e.g., minerals and organic matter (e.g., organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure and straw manure. Depending on its origin, manure can be divided into manure derived from animals or plants. Common forms of animal manure include feces, urine, farm slurry (liquid manure) or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depends on the origin (type of animals). Plant manures may derive from any kind of plant whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer) or seaweed.

As used herein, the term “seed” comprises seed of all types, such as, for example, corns, seeds, fruits, tubers, seedlings and similar forms. The seed used can be seed of the useful plants mentioned above, but also the seed of transgenic plants or plants obtained by customary breeding methods.

As used herein, the term “reduce volatility” and the like refers to the volatility of the nitrapyrin-monoacid mixture or complex as compared to that of the nitrapyrin free base. The reduction in volatility can be quantified as described elsewhere herein.

As used herein, the term “organic solvent” refers to a nonaqueous solvent that solvates the nitrapyrin-monoacid complex to the degree as described elsewhere herein.

As used herein, the term “nonaqueous” refers to a solvent that has a water content of less than 0.2% by weight based on the total weight of the solvent.

As used herein, the term “inhibit urease” and the like refers to the inhibition of the activity of urease. The inhibition can be quantified as described elsewhere herein.

As used herein, the term “nitrification inhibitor” refers to a property of a compound, such as nitrapyrin, to inhibit oxidation of ammonia to nitrite/nitrate.

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the transitional phrase “consisting essentially of” limits the scope of a claim to the specified materials or steps “and those that do not materially affect the basic and novel characteristic(s)” of the claimed invention.

As used therein, the transitional phrase “consisting of” excludes any element, step, or ingredient not specified in the claim.

Additional definitions may follow below.

### II. Compositions

Nitrapyrin complexes or mixes with monoacid(s) selected from monocarboxylic acids, monosulfonic acids and monophosphonic acids have been prepared. In some embodiments, the monohosphonic acid is not phosphoric acid (i.e., the nitrapyrin is not complexed or mixed with phosphoric acid). In some embodiments, the monoacid(s) are substituted. In such embodiments, the nitrapyrin complexes or mixes with substituted monocarboxylic acids, monosulfonic acids, monophosphonic acids and/or any combination thereof. As mentioned above, these complexes and mixtures can exhibit desirable properties such as a significantly lower vapor pressure, higher loading, and increased chemical stability, all of which generally contribute to an increased performance in the field.

The amount of nitrapyrin and monoacid present in the complex/mixture can vary. In some embodiments, nitrapyrin and monoacid are present in a weight ratio of from about 1000:1 to about 1:1000, from about 750:1 to about 1:750, from about 1:500 to about 500:1, from about 1:250 to about 250:1, from about 1:100 to about 100:1, from about 75:1 to about 1:75, from about 1:50 to about 50:1, from about 1:25 to about 25:1, from about 1:20 to about 20:1, from about 1:15 to about 15:1, from about 1:10 to about 10:1, from about 1:5 to about 5:1, from about 1:3 to about 3:1, from about 1:2.5 to about 2.5:1, from about 1:2 to about 2:1, or is about 1:1.

Generally, the nitrapyrin-monoacid complex/mixture can be used neat in the composition or the composition can include an organic solvent, as well as other ingredients to form useful compositions. In some embodiments, the described compositions and formulations contain relatively little to no water. Formulations containing high amounts of water have shown rapid degradation of nitrapyrin and therefore the exposure of nitrapyrin to excessive amounts of water should be minimized. In some embodiments, the amount of water present in neat nitrapyrin-monoacid complex or mixture or in a formulation thereof containing organic solvent is less than about 10%, about 9%, about 8%, about 7%, about 6%, about 5%, about 4%, about 3%, about 2%, about 1%, or is less than 0.5% w/w based on the total weight of the composition. In such compositions, the chemical stability of the nitrapyrin complex/mixture is at least about 50%, about 60%, about 70%, about 80%, about 85%, about 90%, about 91%, about 92%, about 93%, about 94%, about 95%, about 96%, about 97%, about 98%, about 99%, or at least about 99.5%. See for example, Meikle et al. “The hydrolysis and photolysis rates of nitrapyrin in dilute aqueous solution” Arch. Environm. Contain. Toxicol. 7, 149-158 (1978).

In some embodiments, complexation of nitrapyrin with a monoacid as disclosed herein can be characterized by a color change of the complexed nitrapyrin. For example, nitrapyrin by itself is a colorless crystalline white solid and is a clear solution when dissolved in an organic solvent. However, a color change of nitrapyrin can be observed when complexed with a monoacid, particularly in the presence of an organic solvent. The color of the resulting nitrapyrin-monoacid complex and any solutions thereof with an organic solvent can vary depending upon the amount of nitrapyrin and/or monoacid and/or solvent present as well as the functionality of the monoacid and/or solvent. In some embodiments, a color change of nitrapyin is not observed in the presence of a monoacid. Not to be bound by theory but it is believed that in such instances nitrapyin may not be complexed with the monoacid but rather form a nitrapyin-monoacid mixture. Surprisingly these nitrapyin-monoacid mixture can also exhibit essentially the same beneficial properties as nitrapyrin-monoacid complexes.

### A. Nitrapyrin Complexes and Mixtures with Monoacid(s)

Nitrapyrin is a nitrification inhibitor having the structure:

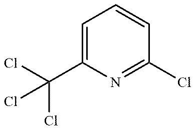 [SMILES: Clc1cccc(C(Cl)(Cl)Cl)n1]

It functions to inhibit nitrification within the soil bacteria, Nitrosomonas, which act on ammonia by oxidizing ammonium ions to nitrite and/or nitrate. Nitrification inhibition therefore reduces nitrogen emissions from soil.

Mixtures and complexes of nitrapyrin include those formed with a suitable nonvolatile monoacid. The monoacid is selected from a monocarboxylic acid, a monosulfonic acid, and/or a monophosphonic acid. In some embodiments, the monophosphonic acid is not phosphoric acid. In some embodiments, the monoacid is substituted. In some embodiments, the monoacid is selected from a monocarboxylic acid (substituted or unstubstiuted), a monosulfonic acid, a monophosphonic acid and a combination thereof. In some embodiments, nitrapyin mixes or complexes with a monoacid containing an aromatic ring system. In some embodiments, nitrapyrin complexes or mixes with a monoacid that is a monocarboxylic acid. For example, formic acid. In some embodiments, the monocarboxylic acid is substituted with an alkyl, alkenyl, or aromatic ring system. Exemplary alkyl monocarbocylic acids include, but are not limited to, acetic acid, propionic acid, butanoic acid, pentanoic acid, hexanoic acid, octanoic acid, nonanonic acid, and decanoic acid. Exemplary alkenyl monocarboxylic acids include, but are not limited to, acrylic acid, 3-butenoic acid, 4-pentenoic acid, 5-hexenoic acid, 6-heptenoic acid, 7-octenoic acid, 8-nonenoic acid, and 9-decenoic acid. Exemplary aromatic ring system monocarboxylic acids include, but are not limited to, (un)substituted benzoic acid, (un)substituted 4-pyridinecarboxylic acid, (un)substituted nicotinic acid, (un)substituted 5-pyrimidinecarboxylic acid, (un)substituted 2-pyrazinecarboxylic acid, (un)substituted 2-quinoxalinecarboxylic acid, and (un)substituted 2-naphthalenecarboxylic acid.

In some embodiments, nitrapyrin complexes or mixes with a monoacid that is a monosulfonic acid. In some embodiments, the monosulfonic acid is substituted with an alkyl, alkenyl, or aromatic ring system. Exemplary alkyl monosulfonic acids include, but are not limited to, methanesulfonic acid, ethanesulfonic acid (e.g., 2-hydroxy-ethanesulfonic acid), 1-propanesulfonic acid (e.g., lignosulfonic acid), 1-butanesulfonic acid, 1-propanesulfonic acid, 1-hexanesulfonic acid, 1-heptanesulfonic acid, 1-octanesulfonic acid, 1-nonanesulfonic acid, and 1-decanesulfonic acid. Exemplary alkenyl monosulfonic acids include, but are not limited to, vinylsulfonic acid, allylsulfonic acid, 3-butene-1-sulfonic acid, 4-pentene-1-sulfonic acid, 5-hexene-1-sulfonic acid, 6-heptene-1-sulfonic acid, 7-octene-1-sulfonic acid, 8-nonene-1-sulfonic acid, and 9-decene-1-sulfonic acid. Exemplary aromatic ring system monosulfonic acids include, but are not limited to, (un)substituted benzenesulfonic acid (e.g., cumene sulfonic acid, toluene sulfonic acid, xylene sulfonic acid), (un)substituted 4-pyridinesulfonic acid, (un)substituted 3-pyridinesulfonic acid, (un)substituted 5-pyrimidinesulfonic acid, (un)substituted 2-pyridinesulfonic acid, (un)substituted 2-quinoxalinesulfonic acid, and (un)substituted 2-naphthalenesulfonic acid.

In some embodiments, nitrapyrin complexes or mixes with a monoacid that is a monophosphonic acid. In some embodiments, the monophosphonic acid is not phosphoric acid. In some embodiments, the monophosphonic acid is substituted with an alkyl, alkenyl, or aromatic ring system. Exemplary alkyl monophosphonic acids include, but are not limited to, methylphosphonic acid, ethylphosphonic acid, propylphosphonic acid, butylphosphonic acid, pentylphosphonic acid, hexylphosphonic acid, heptylphosphonic acid, octylphosphonic acid, nonylphosphonic acid, and decylphosphonic acid. Exemplary alkenyl monophosphonic acids include, but are not limited to, vinylphosphonic acid, allylphosphonic acid, 3-butene-1-phosphonic acid, 4-pentene-1-phosphonic acid, 5-hexene-1-phosphonic acid, 6-heptene-1-phosphonic acid, 7-octene-1-phosphonic acid, 8-nonene-1-phosphonic acid, and 9-decene-1-phosphonic acid. Exemplary aromatic ring system monophosphonic acids include, but are not limited to, (un)substituted benzenephosphonic acid, (un)substituted 4-pyridinephosphonic acid, (un)substituted 3-pyridinephosphonic acid, (un)substituted 5-pyrimidinephosphonic acid, (un)substituted 2-pyridinephosphonic acid, (un)substituted 2-quinoxalinephosphonic acid, and (un)substituted 2-naphthalenephosphonic acid.

In some embodiments, the alkyl group, the alkenyl group, or the aromatic ring system of the monoacid is further substituted with one or more of —OR₁, —C(═O)R₂, —PO₃H, —PO₃R₄, —SO₃H, —SO₃R₄, —N(R₃)(R₄), -C₁-C₆ alkyl, halogen, —CN, —CF₃, —NO₂ and —CF₃;
wherein R₁ is —H, -C₁-C₆ alkyl, or —C(═O)(C₁-C₆ alkyl);
R₂ is —H, —OH, —N(R₄)(R₄), -C₁-C₆ alkyl, or —O(C₁-C₆ alkyl);
R₃ is —H, -C₁-C₆ alkyl, or —C(═O)(C₁-C₆ alkyl); and
R₄ is —H, or -C₁-C₆ alkyl.

In some embodiments, the alkyl group, the alkenyl group, or the aromatic ring system of the monoacid is further substituted with one or more of -ORi, —C(═O)R₂ and -C₁-C₆ alkyl;
wherein R₁ is —H, -C₁-C₆ alkyl, or —C(═O)(C₁-C₆ alkyl); and
R₂ is —H, —OH, -C₁-C₆ alkyl, or —O(C₁-C₆ alkyl).

In some embodiments, the alkyl group, the alkenyl group, or the aromatic ring system of the monoacid is further substituted with one or more of halogen(s), —OH, —OCH₃, —C(═O)H, -COOH, —C(═O)CH₃, —C(═O)OCH₃, —OC(═O)CH₃, —CH₃, —NH₂, —NHCH₃, —N(CH₃)₂, and —NC(═O)CH₃.

In some embodiments, the alkyl group, the alkenyl group, or the aromatic ring system of the monoacid is further substituted with one or more of halogen(s), —OH, —OCH₃, —C(═O)H, -COOH, —C(═O)CH₃, —C(═O)OCH₃, —OC(═O)CH₃, and —CH₃.

In some embodiments, the alkyl group, the alkenyl group, or the aromatic ring system of the monoacid is further substituted with one or more of halogen(s), —OH, —OCH₃, and —C(═O)H, -COOH.

In some embodiments, the alkyl group, the alkenyl group, or the aromatic ring system of the monoacid is further substituted with one or more of —OH, —OCH₃, and -COOH.

In some embodiments, the monoacid is substituted with an aromatic ring system. In some embodiments, the aromatic ring system comprises one or more heteroatoms selected from N, S, and O. In some embodiments, the aromatic ring system is a heteroaryl ring system. In some embodiments, the aromatic ring system is an aryl ring system. In some embodiments, the aryl ring system is a phenyl ring. In some embodiments, the monoacid that is substituted with an aryl ring system is a monocarboxylic acid.

In some embodiments, nitrapyrin is complexed or mixed with a monoacid, wherein the monoacid is a compound of Formula (I):

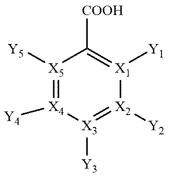

wherein X₁, X₂, X₃, X₄, and X₅ are independently selected from C and N, provided that no more than three of X₁, X₂, X₃, X₄, and X₅ are N and three N's are not directly adjacent to one another; and Y₁, Y₂, Y₃, Y₄, and Y₅ are independently selected from H, —OR₁, —C(═O)R₂, C₁-C₆ alkyl, —N(R₃)(R₄), and being absent,
wherein R₁ is —H, -C₁-C₆ alkyl, or —C(═O)(C₁-C₆ alkyl);
R₂ is —H, —OH, —N(R₄)(R₄), -C₁-C₆ alkyl, or —O(C₁-C₆ alkyl);
R₃ is —H, -C₁-C₆ alkyl, or —C(═O)(C₁-C₆ alkyl); and
R₄ is —H or -C₁-C₆ alkyl.

In some embodiments, X₁, X₂, X₃, X₄, and X₅ are C. In some embodiments, Y₁, Y₂, Y₃, Y₄, and Y₅ are independently selected from —H, —OH, —OCH₃, —C(═O)OH, -C₁-C₆ alkyl, and being absent. In some embodiments, Y₁, Y₂, Y₃, Y₄, and Y₅ are independently selected from —H, and —OH.

In some embodiments, the monoacid is a resorcylic acid. Exemplary resorcylic acids, which are a type of dihydroxybenzoic acid, include, but are not limited to, 3,5-dihydroxybenzoic acid (3,5-DHB acid), 2,4-dihydroxybenzoic acid (2,4-DHB acid), 2,6-dihydroxybenzoic acid (2,6-DHB acid) and any isomers and/or mixtures thereof. In some embodiments, the monoacid is a catechol acid. Exemplary catechol acids include, but are not limited to, 2,3-dihydroxy benzoic acid (2,3-DHB acid) and/or 3,4-dihydroxybenzoic acid (3,4-DHB acid). In some embodiments, the monoacid is a hydroquinone (HQ) acid. An exemplary HQ acid is 2,5-dihydroxybenzoic acid (2,5-DHB acid).

In some embodiments, the monoacid is a monocarboxylic acid selected from 4-hydroxy-3-methoxybenzoic acid (Vanillic Acid), 3,4-dimethoxybenzoic acid, and 2,4-dihydroxybenzoic acid (2,4-DHB acid). In some embodiments, the monoacid is a monosulfonic acid such as methanesulfonic acid.

In some embodiments, the monoacids suitable for formation of useful complexes or mixtures with nitrapyrin have one or more of: lower vapor pressure when compared to the vapor pressure of nitrapyrin that is not complexed or mixed with a monoacid, and/or lower volatility when compared to the volatility of nitrapyrin that is not complexed or mixed with a monoacid. In some embodiments, the vapor pressure of the nitrapyrin in the nitrapyrin-monoacid complex or mixture is less than 0.5 mmHg at 20° C. Furthermore, the amount of loading of the nitrapyrin into a formulation has been significantly increased.

In some embodiments, a nitrapyrin-monoacid complex or mixture can be formed with one, two or more monoacid(s). In some embodiments, the monoacid(s) are different. In some embodiments, the monoacid(s) are the same.

In some embodiments, nitrapyrin can be present as a mixture of the complex and the free form. The ratio of complex to free form can be from 1000:1 to 0.1:1 such that the compositions can reduce the volatilization losses of nitrapyrin to atmosphere by at least 10% as compared to an identical composition lacking the complex described herein (i.e., nitrapyrin that is not complexed to one or more monoacid(s)). Accordingly, the compositions described herein can simultaneously comprise the complex and the free form so long as the volatilization losses are reduced as described elsewhere herein.

In some embodiments, a nitrapyrin-monoacid complex can form in the absence of a solvent (e.g., an organic solvent). In some embodiments, a nitrapyrin-monoacid complex is formed in the presence of a solvent (e.g., an organic solvent).

### B. Organic Solvents

In some embodiments, the solvent is an organic solvent. In some embodiments, the solvent is a polar organic solvent. In some embodiments, the polar organic solvent is EPA approved. EPA approved solvents are those that are approved for food and nonfood use and found in the electronic code of federal regulations, for example in Title 40, Chapter I, Subchapter E, Part 180. EPA approved solvent include, but are not limited to, the solvents listed in Table 1. EPA approved solvents:

| 1,3-Propanediol (CAS Reg. No. 504-63-2) | Isopropyl-3-hydroxybutyrate (CAS Reg. No. 54074-94-1) |
|---|---|
| 2-Ethylhexanol | Kerosene, U.S.P. reagent |
| 2-methyl-1,3-propanediol (CAS Reg. No. 2163-42-0) | Lactic acid |
| 2-Methyl-2,4-pentanediol | Lactic acid, 2-ethylhexyl ester (CAS Reg. No. 6283-86-9) |
| Acetic anhydride | Lactic acid, n-propyl ester, (S); (CAS Reg. No. 53651-69-7) |
| Acetone (CAS Reg. No. 67-64-1) | Mesityl oxide |
| Ammonium hydroxide | Methyl 5-(dimethylamino)-2-methyl-5-oxopentanoate (1174627-68-9) |
| Amyl acetate | Methyl alcohol |
| Benzyl acetate (CAS Reg. No. 140-11-4) | Methyl esters of fatty acids derived from edible fats and oils |
| C₁₀₋₁₁ rich aromatic hydrocarbons (CAS Reg. No. 64742-94-5) | Methyl isobutyl ketone |
| C₁₁₋₁₂ rich aromatic hydrocarbons (CAS Reg. No. 64742-94-5) | Methyl isobutyrate (CAS Reg. No. 547-63-7) |
| C₉ rich aromatic hydrocarbons (CAS Reg. No. 64742-95-6) | Methyl n-amyl ketone (CAS Reg. No. 110-43-0) |
| Choline chloride (CAS Reg. No. 67-48-1) | Mineral oil |
| Cod liver oil | Morpholine 4-C₆₋₁₂ Acyl Derivatives (CAS Reg. No. 887947-29-7) |
| Cyclohexane | n-Butanol (CAS Reg. No. 71-36-3) |
| Cyclohexanone | n-Butyl benzoate (CAS Reg. No.136-60-7) |
| Decanamide, N,N-dimethyl (CAS Reg. No. 14433-76-2) | n-Butyl-3-hydroxybutyrate (CAS Reg. No. 53605-94-0) |
| Diethylene Glycol (CAS No. 111-46-6) | n-Decyl alcohol (CAS Reg. No. 112-30-1) |
| Diethylene glycol mono butyl ether (CAS Reg. No. 112-34-5) | n-Hexyl alcohol (CAS Reg. No. 111-27-3) |
| Diethylene Glycol MonoEthyl Ether (CAS Reg. No. 111-90-0) | N-Methylpyrrolidone (CAS Reg. No. 872-504) |
| Diethylphthalate | n-Octyl alcohol (CAS Reg. No. 111-87-5) |
| Diisopropyl adipate (CAS Reg. No. 6938-94-9) | n-Propanol |
| Dimethyl adipate (CAS no. 627-93-0) | Octanamide, N,N-dimethyl (CAS Reg. No. 1118-92-9) |
| Dimethyl glutarate (CAS no. 1119-40-0) | Oxo-decyl acetate (CAS reg. No. 108419-33-6) |
| Dimethyl succinate (CAS no. 106-65-0) | Oxo-heptyl acetate (CAS Reg. No. 90438-79-2) |
| Dimethyl sulfoxide (CAS No. 67-68-5) | Oxo-hexyl acetate (CAS Reg. No. 88230-35-7) |
| Di-n-butyl carbonate (CAS Reg. No. 542-52-9) | Oxo-nonyl acetate (CAS Reg. No. 108419-34-7) |
| Dipropylene glycol | Oxo-octyl acetate (CAS Reg. No. 108419-32-5) |
| Distillates, (Fishcher-Tropsch), heavy, C₁₈-C₅₀, branched, cyclic and linear (CAS Reg. No. 848301-69-9) | Oxo-tridecyl acetate (CAS Reg. No. 108419-35-8) |
| d-Limonene (CAS Reg. No. 5989-27-5) | Petroleum hydrocarbons, light odorless conforming to 21 CFR 172.884 |
| Edible fats and oils. | Phenol |
| Ethyl acetate | Propanoic acid, 2-methyl-, monoester with 2,2,4-trimethyl-1,3-pentanediol (CAS Reg. No. 25265-77-4) |
| Ethyl alcohol | Propylene glycol |
| Ethyl esters of fatty acids derived from edible fats and oils | Propylene glycol monomethyl ether (CAS No. 107-98-2) |
| Ethylene glycol (CAS Reg. No. 107-21-1) | Soybean oil-derived fatty acids |
| Glycerol mono-, di-, and triacetate | Tall oil fatty acid (CAS Reg. No. 61790-12-3) |
| Hydrochloric acid | Tetraethylene glycol (CAS Reg. No. 112-60-7) |
| Isobornyl acetate | Toluenesulfonic acid |
| Isobutyl Acetate (CAS Reg. No. 110-19-0) | Triacetin (glyceryl triacetate) |
| Isobutyl isobutyrate (CAS Reg. No. 97-85-8) | Xylene |
| Isobutyric Acid (CAS Reg. No. 79-31-2) | γ-Butyrolactone |
| Isopropyl myristate (CAS Reg. No. 110-27-0) | |

In some embodiments, the organic solvent is selected from a sulfone, a sulfoxide, an oil, an aromatic solvent, a halogenated solvent, a glycol-based solvent, a fatty acid-based solvent, and an acetate-containing solvent, a ketone containing solvent, ether polyol-containing solvent, an amide-containing solvent, and combinations thereof. In some embodiments, the organic solvent is a sulfone. A sulfone solvent can be, but is not limited to, sulfolane, methyl sulfolane (3-methyl sulfolane), dimethyl sulfone, and a combination thereof. In some embodiments, the organic solvent is a sulfoxide. A sulfoxide solvent can be, but is not limited to, dimethyl sulfoxide.

In some embodiments, the organic solvent is an etherpolyol. An etherpolyol solvent can be, but is not limited to, polyethylene glycols, polypropylene glycols, polyalkylene glycols, and related compounds. In some embodiments, the polyethylene glycol has two terminal alcohols. Exemplary polyethylene glycols include, but are not limited to, diethylene glycol, triethylene glycol, and a combination thereof. Exemplary polypropylene glycols include, but are not limited to, dipropylene glycol, tripropylene glycol and a combination thereof. In some embodiments, a polypropylene glycol has three terminal alcohols. Exemplary polypropylene glycols having three terminal alcohols, known as propoxylated glycerol, include, but are not limited to, Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, etherpolyol comprises a polyethylene or a polypropylene glycol in the molecular weight range of between about 200 and about 10,000 Da. In some embodiments, one or more of the hydroxyl groups present in the ether polyol is modified. For example, in some embodiments, one or more of the hydroxyl groups present in the ether polyol are alkylated and/or esterified. Exemplary modified ether polyols include, but are not limited to, triacetin, n-butyl ether of diethylene glycol, ethyl ether of diethylene glycol, methyl ether of diethylene glycol, acetate of the ethyl ether of dipropylene glycol, and any combination thereof. In some embodiments, the ether polyol is a cyclic carbonate ester (e.g., propylene carbonate). It has been found that nitrapyrin-monoacid complex compositions containing ether polyols are more suitable for formation of higher solids and/or actives content than previously described compositions containing esters. In some embodiments, the ether-polyol is a liquid at 20° C. In some embodiments, the ether-polyol is a solid at 20° C.

In some embodiments, the organic solvent is a glycol-based solvent. A glycol is an alcohol that contains two hydroxyl (-OH) groups that are attached to different carbon atoms (e.g., terminal carbon atoms). The simplest glycol is ethylene glycol, although the solvent should not be limited thereto.

In some embodiments, the organic solvent is an oil. Exemplary oils include, but are not limited to, mineral oil and/or kerosene.

In some embodiments, the organic solvent is a fatty acid-based solvent. In some embodiments, the fatty acid contains between 3 to about 20 carbon atoms. An example of a fatty acid-based solvent includes, but is not limited to, a dialkyl amide of a fatty acid (e.g., a dimethylamide). Examples of a dimethylamide of a fatty acid include, but are not limited to, a dimethyl amide of a caprylic acid, a dimethyl amide of a C8-C10 fatty acid (Agnique® AMD 810 (N,N-dimethyloctanamide, CAS Number 1118-92-9 and N,N-dimethyldecanamide, CAS Number 14433-76-2)), a dimethyl amide of a natural lactic acid (Agnique® AMD 3L ((N,N-dimethylactamide; CAS Number 35123-06-9)), and a combination thereof.

In some embodiments, the organic solvent is a ketone-containing solvent. Examples of ketone-containing solvent include, but are not limited to, isophorone, trimethylcyclohexanone, and a combination thereof.

In some embodiments, the organic solvent is an acetate-containing solvent. Examples of acetate-containing solvents include, but are not limited to, acetate, hexyl acetate, heptyl acetate, and a combination thereof.

In some embodiments, the organic solvent is an amide-containing solvent. Examples of amide-containing solvents include, but are not limited to, Rhodiasolv® ADMA 10 (CAS No: 14433-76-2; N,N-dimethyloctanamide), Rhodiasolv® AMD 810 (CAS No: 1118-92-9/14433-76-2; blend of N,N-dimethyloctanamide and N,N-dimethyldecanamide), Rhodiasolv® Polarclean (CAS No: 1174627-68-9; methyl 5-(dimethylamino)-2-methyl-5-oxopentanoate), and a combination thereof.

In some embodiments, the organic solvent is a halogentated solvent. In some embodiments, the halogentated solvent is a halogentated aromatic hydrocarbon. An example of a halogenated aromatic hydrocarbon is chlorobenzene. In some embodiments, the halogentated solvent is a halogentated aliphatic hydrocarbon. An example of a halogenated aliphatic hydrocarbon is 1,1,1-trichloroethane.

In some embodiments, the organic solvent is an aromatic solvent. In some embodiments, the aromatic solvent is an aromatic hydrocarbon. Exemplary aromatic hydrocarbons include but are not limited to, benzene, napthylene, and a combination thereof. In some embodiments, the aromatic hydrocarbon is substituted. Examples of substituted aromatic hydrocarbons include, but are not limited to, alkyl substituted benzens and/or alkyl substituted naphthalenes. Examples of alkyl substituted benzenes include xylene, toluene, propylbenzene, and a combination thereof. In some embodiments, the organic solvent comprises xylene. In some embodiments, the aromatic hydrocarbon is a mixture of substituted and unsubstituted aromatic hydrocarbons, such as, but not limited to, a mixture of naphthalene and alkyl substituted naphthalene.

In some embodiments, the aromatic solvent is a mixture of hydrocarbons. For example, in some embodiments, the aromatic solvent is aromatic 100, a solvent containing Naphtha (CAS No: 64742-95-6), which is a combination of hydrocarbons obtained from distillation of aromatic streams consisting predominantly of aromatic hydrocarbons C8 through C10, or aromatic 200, a solvent containing a mixture of: aromatic hydrocarbon (C11-C14) present in 50-85% by weight; Naphthalene (CAS No: 91-20-3) present in 5-20% by weight; aromatic hydrocarbon (C10) not including naphthalene present in 5-15% by weight, and aromatic hydrocarbon (C15-C16) present in 5-15% by weight based on the total weight of the aromatic 200 composition. In some embodiments, the aromatic hydrocarbon is a mixture of aromatic 100 and aromatic 200.

In some embodiments, an organic solvent can be, but is not limited to, aromatic solvent (such as but not limited to, alkyl substituted benzene, xylene, propylbenzene, mixed naphthalene and alkyl naphthalene); mineral oils; kerosene; dialkyl amides of fatty acids, (including but not limited to, dimethylamides of fatty acids, dimethyl amide of caprylic acid); chlorinated aliphatic and aromatic hydrocarbons (including but not limited to, 1, 1, 1-trichloroethane, chlorobenzene); esters of glycol derivatives (e.g., n-butyl, ethyl, or methyl ether of diethyleneglycol and acetate of the methyl ether of dipropylene glycol); ketone-containing solvents (e.g., including but not limited to, isophorone and trimethylcyclohexanone (dihydroisophorone)); and acetate-containing solvents (including but not limited to, hexyl and heptyl acetate).

In some embodiments, an organic solvent can be, but is not limited to, aromatic 100 (CAS No: 64742-95-6), aromatic 200 (CAS No. 64742-94-5), a sulfone, glycol-based solvent, an ether polyol (e.g., dipropylene glycol, Dow PT250, Dow PT700, PT250, triethylene glycol, tripropylene glycol, propylene carbonate, triacetin), dialkylamides of saturated monocarboxylic fatty acids containing between 3 and 20 carbon atoms (such as Agnique® AMD 810, Agnique® AMD 3L), amide-containing solvent (e.g., Rhodiasolv® ADMA 10, Rhodiasolv® Polarclean and Rhodiasolv® ADMA 810), or mixtures thereof.

In some embodiments, the organic solvent is relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent.

In some embodiments, the amount of organic solvent in the composition containing the nitrapyrin-monoacid complex or mixture can vary. In some embodiments, the amount of solvent present in the composition is from about 10% to about 90% w/w, from about 20% to about 80% w/w, from about 30% to about 70% w/w, 50% to about 65% w/w, from about 55% to about 60% w/w, from about 55% to about 60% w/w, or from 55% to about 65% w/w based on the total weight of the composition.

In some embodiments, the organic solvent is a liquid at 20° C. In other embodiments, the organic solvent is a solid at 20° C.

In some embodiments, the composition containing the nitrapyrin-monoacid complexes or mixtures can be formulated with two different solvent types. Nitrapyrin-monoacid complexes or mixtures formulated in two different solvent types can exhibit high solvation, relative lack of volatility, and suitable environmental and toxicological profiles. The two different solvent types can be selected from two different aromatic solvents, two different amide-containing solvents, two different sulfoxides, or a sulfoxide and an aromatic solvent, or a sulfoxide and an amide-containing solvent. In some embodiments, the two different solvent types are xylene and dimethylsulfoxide (DMSO). In some embodiments, the two different solvent types are dimethylsulfoxide (DMSO) and Rhodiasolv® Polarclean. The amount of each solvent type present in the composition containing the nitrapyrin-monoacid complex or mixture can vary. In some embodiments, the first solvent of the two different solvent types is present in an amount ranging from about 10% to about 90% w/w, from about 20% to about 80% w/w, from about 30% to about 70% w/w, or from about 40% to about 60% w/w based on the total weight of the composition. In some embodiments, the second solvent of the two different solvent type is present in an amount ranging from about 10% to about 90% w/w, from about 20% to about 80% w/w, from about 30% to about 70% w/w, or from about 40% to about 60% w/w based on the total weight of the composition. In some embodiments, the first solvent is dimethylsulfoxide (DMSO). In some embodiments, the second solvent is xylene or Rhodiasolv® Polarclean. In some embodiments, the first solvent is present in an amount of about 50% w/w based on the total weight of the composition.

In some embodiments, the amount of the first solvent and the amount of the second solvent are present in a weight ratio of from about 100:1 to about 1:100, from about 75:1 to about 1:75, from about 50:1 to about 1:50, from about 25:1 to about 1:25, from about 20:1 to about 1:20, from about 15:1 to about 1:15, from about 10:1 to about 1:10, from about 5:1 to about 1:5, from about 4:1 to about 1:4, from about 3:1 to about 1:3, from about 2:1 to about 1:2, or about 1:1.

In some embodiments, solvency of the nitrapyrin in solution/solvent at 20° C. is greater than 15% w/w (nitrapyrin to total weight), for example from about 15 to about 22% w/w, or about 17% to about 21% w/w, or greater than 16% w/w, greater than 17% w/w, greater than 18% w/w, greater than 19% w/w, greater than 20% w/w, greater than 21% w/w, greater than 22% w/w, greater than 23% w/w, greater than 24% w/w, or greater than 25% w/w greater than 26% w/w, greater than 27% w/w, greater than 28% w/w, greater than 29% w/w, greater than 30% w/w, greater than 35% w/w, greater than 40% w/w, or greater than 45% w/w.

The solvent can be present in the composition at an amount from 0.1% w/v to about 99.9% w/v. In some embodiments, the amount of solvent will be minimized as the amount of nitrapyrin-monoacid complex or mixtureis maximized. In some embodiments, the amount of solvent is less than 80% w/v, less than 79% w/v, less than 78% w/v, less than 77% w/v, less than 76% w/v, less than 75% w/v, less than 74% w/v, less than 73% w/v, less than 72% w/v, less than 71% w/v, less than 70% w/v, less than 65% w/v, less than 60% w/v, or less than 55% w/v. In some embodiments, the amount of solvent is from 55% w/v to about 98% w/v; or from about 60% w/v to about 97% w/v; or from about 61% w/v to about 95% w/v; or from about 62% w/v to about 90% w/v; or from about 63% w/v to about 85% w/v; or from about 64% w/v to about 80% w/v.

The composition comprises nitrapyrin in the form of a complex or a mixture. Advantageously, nitrapyrin complexes or mixtures with monoacid(s) selected from monocarboxylic acids, monosulfonic acids, and monophosphonic acids have been found to provide excellent loading heretofore not disclosed. Advantages of the highly concentrated compositions include lower cost of shipping and ease of handling. In some embodiments, the compositions comprise nitrapyrin in a range from about 1% to about 50% by wt. based on the total weight of the composition. In some embodiments, the compositions comprise nitrapyrin in a range from about 10% to about 50% by wt. based on the total weight of the composition. In some embodiments, the compositions comprise nitrapyrin in a range from about 20% to about 50% by wt. based on the total weight of the composition. In some embodiments, the compositions comprise nitrapyrin in a range from about 25% to about 50% by wt. based on the total weight of the composition. In some embodiments, the compositions comprise nitrapyrin in a range from about 30% to about 50% by wt. based on the total weight of the composition. In some embodiments, the compositions comprise nitrapyrin in a range from about 25% to about 45% by wt. based on the total weight of the composition. In some embodiments, the compositions comprise nitrapyrin in a range from about 25% to about 40% by wt. based on the total weight of the composition. In some embodiments, the compositions comprise nitrapyrin in a range from about 25% to about 35% by wt. based on the total weight of the composition. In some embodiments, the compositions comprise nitrapyrin in a range from about 28% to about 32% by wt. based on the total weight of the composition. In some embodiments, the compositions comprise nitrapyrin in an amount of about 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% by wt. based on the total weight of the composition.

The amount of the monoacid present in the complex can vary. In some embodiments, the amount of monoacid present in the nitrapyrin-monoacid complex or mixture is from about 1% to about 80% w/w, from about 10% to about 70% w/w, from about 10% to about 60% w/w, from about 10% to about 50% w/w, from about 20% to about 50%, from about 35% to about 55%, from about 40% to about 50%, from about 1% to about 40% w/w from about 1% to about 30% from about 5% to about 25% w/w from about 10% to about 20% w/w, from about 10% to about 15% w/w, or from about 15% to about 20% w/w based on the total weight of the nitrapyrin-monoacid-containing composition. Furthermore, a skilled artisan would also be aware that select monoacids can only be present in the composition in certain amounts due to their toxicological and environmental profile. Exemplary acids include, but are not limited to, 2-hydroxy ethanesulfonic acid, lignosulfonic acid, cumene sulfonic acid, toluenesulfonic acid, xylenesulfonic acid, and methane sulfonic acid. A skilled artisan would have knowledge of what types of acids exhibit undesirable toxicological and environmental properties and would adjust their amounts in the composition accordingly. For example, the composition disclosed herein may comprise a monoacid selected from 2-hydroxy ethanesulfonic acid, lignosulfonic acid, cumene sulfonic acid, toluenesulfonic acid, xylenesulfonic acid, and methanesulfonic acid in an amount of less than about 3%, about 2.5%, about 2.0%, about 1.5%, about 1.0%, about 0.9%, about 0.8%, about 0.7%, about 0.6%, about 0.5%, about 0.4%, about 0.3%, about 0.2%, about 0.1%, or about 0.01% based on the total weight of the composition.

The amount of the nitrapyrin-monoacid complex/mixture comprising nitrapyrin and monoacid can vary. In some embodiments, the composition comprises neat nitrapyrin-monoacid complex/mixture and no solvent is present (which means that the amount of nitrapyrin-monoacid complex/mixture is 100% w/w based on the total weight of the composition). In some embodiments, the composition comprises the nitrapyrin-monoacid complex/mixture and a solvent. In such embodiments, the nitrapyrin-monoacid complex/mixture is present in an amount of from about 20% to about 80% w/w from about 25% to about 75% w/w, from about 30% to about 60% w/w, from about 35% to about 55% w/w, or from about 40% to about 50% w/w based on the total weight of the composition.

In some embodiments, compositions containing nitrapyrin-monoacid complexes/mixtures are disclosed. The nitrapyrin-monoacid complexes/mixtures are more readily dissolved in appropriate solvents when compared to nitrapyrin alone or with prior art formulations. The described nitrapyrin-monoacid complexes/mixtures can form solutions that are greater than or equal to 25% nitrapyrin by weight. Suitable solvents include, but are not limited to, aromatic 100 (CAS No: 64742-95-6), aromatic 200 (CAS No. 64742-94-5), sulfones (e.g., dimethylsulfoxide (DMSO)), amide-containing solvent (e.g., Rhodiasolv® Polarclean), aromatic solvents (e.g., xylene) and glycols. In some embodiments, the organic solvent is DMSO and xylene. In some embodiments, the solvent is DMSO and Rhodiasolv® Polarclean. In some embodiments, the solvent is Rhodiasolv® Polarclean.

In some embodiments, the composition comprises nitrapyrin in an amount of about 20% to about 30% w/w, a monoacid in an amount of about 10% to about 50% w/w and an organic solvent in an amount of about 20% to about 60% w/w based on the total weight of the composition.

In some embodiments, the composition comprises nitrapyrin in an amount of about 20% to about 30% w/w, a monoacid in an amount of about 10% to about 20% w/w and an organic solvent in an amount of about 50% to about 60% w/w based on the total weight of the composition.

In some embodiments, the composition comprises nitrapyrin in an amount of about 20% to about 30% w/w, a monoacid selected from 3,4-DHB acid, 2,4-DHB acid, 2,5-DHB acid, Vanillic Acid, 3,4-dimethoxybenzoic acid, methanesulfonic acid, and any combination thereof present in an amount of about 10% to about 50% w/w and an organic solvent selected from Rhodiasolv® Polarclean, DMSO, xylene and any combination thereof present in an amount of about 20% to about 60% w/w based on the total weight of the composition.

In some embodiments, the composition comprises nitrapyrin in an amount of about 20% to about 30% w/w, a monoacid selected from 3,4-DHB acid, 2,4-DHB acid, 2,5-DHB acid, Vanillic Acid, 3,4-dimethoxybenzoic acid, methanesulfonic acid, and any combination thereof present in an amount of about 10% to about 20% w/w and an organic solvent selected from Rhodiasolv® Polarclean, DMSO, xylene and any combination thereof present in an amount of about 50% to about 60% w/w based on the total weight of the composition.

In some embodiments, the composition has a solid content that can vary. In some embodiments, the solids content of the composition ranges from about 10% to about 50% w/w, from about 20% to about 50% w/w, from about 30% to about 50% w/w, from about 35% to about 50% w/w, from about 40% to about 50% w/w from about 35% to about 45% w/w, from about 40% to about 45% w/w or from about 45% to about 50% w/w based on the total weight of the composition.

In some embodiments, the nitrapyrin complexed with a monoacid as disclosed herein and compositions comprising these complexes or mixtures reduce volatility of the nitrapyrin by about 5% to about 40% relative to untreated nitrapyrin (i.e., a nitrapyrin that is not complexed or mixed with a monoacid selected from a monocarboxylic acid, a monosulfonic acid, and a monophosphonic acid. In some embodiments, the monophosphonic acid is not phosphoric acid. In some embodiments, the nitrapyrin complexed or mixed with a monoacid as disclosed herein and compositions comprising these complexes or mixtures reduce volatility of the nitrapyrin by about 8% to about 35% relative to untreated nitrapyrin. In some embodiments, the nitrapyrin complexed or mixed with a monoacid and compositions comprising the complexes or mixtures reduce volatility of the nitrapyrin by from about 10% to about 40%, from about 10% to about 35%, from about 10% to about 30%, from about 15% to about 35%, from about 15% to about 30%, from about 20% to about 30% or from about 25% to about 35% relative to untreated nitrapyrin. In some embodiments, the nitrapyrin complexed or mixed with a monoacid and compositions comprising these complexes or mixtures reduce volatility of the nitrapyrin by at least about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or at least about 35% compared to untreated nitrapyrin.

In some embodiments, the composition comprises nitrapyin and the following solvent-monoacid acid combinations: 4-hydroxy-3-methoxybenzoic acid (Vanillic Acid), 3,4-dihydroxybenzoic acid; 3,4-dimethoxybenzoic acid; 2,4-dihydroxybenzoic acid; 2,5-dihydroxybenzoic acid, and/or methanesulfonic acid, and one or more of xylene, dimethylsulfoxide (DMSO) and/or Rhodiasolv® Polarclean.

In some embodiments, the composition comprises nitrapyin, solvents xylene and DMSO, and a monoacid selected from 2,4-dihydroxybenzoic acid, 2,5-dihydroxybenzoic acid, 3,4-dihydroxybenzoic acid, Vanillic Acid, 3,4-dimethoxybenzoic acid and a combination thereof.

In some embodiments, the composition comprises nitrapyin, solvents DMSO and Rhodiasolv® Polarclean, and a monoacid selected from, 3,4-dihydroxybenzoic acid, Vanillic Acid, 3,4-dimethoxybenzoic acid and a combination thereof.

In some embodiments, the composition comprises nitrapyrin, solvent Rhodiasolv® Polarclean, and a monoacid selected from 2,4-dihydroxybenzoic acid, 2,5-dihydroxybenzoic acid, and a combination thereof.

### III. Agricultural Compositions

Any of the described nitrapyrin-monoacid complexes/mixtures and compositions comprising these nitrapyrin-monoacid complexes/mixtures can be combined with one or more agricultural products to render an agricultural composition. Agricultural products can be selected from the group consisting of fertilizer, agriculturally active compounds, seed, compounds having urease inhibition activity, nitrification inhibition activity, pesticides, herbicides, insecticides, fungicides, miticides and the like. In some embodiments, the agricultural composition can include an organic solvent such as the ones already discussed above.

In some embodiments, the described nitrapyrin-monoacid complexes/mixtures may be mixed with the fertilizer products, applied as a surface coating to the fertilizer products, or otherwise thoroughly mixed with the fertilizer products. In some embodiments, in such combined fertilizer/nitrapyrin-monoacid complex/mixture compositions, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The nitrapyrin can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/nitrapyrin-monoacid complex/mixture products, the combined product can be applied at a level so that the amount of nitrapyrin-monoacid complex/mixture applied is about 10-150 g per acre of soil, about 30-125 g per acre, or about 40-120 g per acre of soil. The combined products can likewise be applied as liquid dispersions or as dry granulated products, at the discretion of the user. When nitrapyrin-monoacid complexes/mixtures are used as a coating, the nitrapyrin-monoacid complex/mixtures can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

### A. Fertilizers

In some embodiments, the agricultural product is a fertilizer. The fertilizer can be a solid fertilizer, such as, but not limited to, a granular fertilizer, and the nitrapyrin-monoacid complex or mixture can be applied to the fertilizer as a liquid dispersion. The fertilizer can be in liquid form, and the nitrapyrin-monoacid complex or mixture can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrate and/or fertilizers containing molybdenum materials. In some embodiments, the fertilizer is or contains urea, and/or ammonia, including anhydrous ammonia fertilizer. In some embodiments, the fertilizer comprises plant-available nitrogen, phosphorous, potassium, sulfur, calcium, magnesium or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the nitrapyrin-monoacid complex/ mixture is combined with any suitable liquid or dry fertilizer for application to fields and/or crops.

The described nitrapyrin-monoacid complexes/mixtures, or compositions thereof, can be applied with the application of a fertilizer. The nitrapyrin-monoacid complexes/mixtures can be applied prior to, subsequent to, or simultaneously with the application of fertilizers.

Nitrapyrin-monoacid complex/mixture-containing fertilizer compositions can be applied in any manner which will benefit the crop of interest. In some embodiments, a fertilizer composition is applied to growth mediums in a band or row application. In some embodiments, the compositions are applied to or throughout the growth medium prior to seeding or transplanting the desired crop plant. In some embodiments, the compositions can be applied to the root zone of growing plants.

### B. Seed

In some embodiments are described agricultural seeds coated with one or more of the described nitrapyrin-monoacid complexes or mixtures. The nitrapyrin-monoacid complex or mixtures can be present in the seed product at a level of from about 0.001-10%, about 0.004%-2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soy bean, cotton, or oilseed rape.

### C. Other

In some embodiments are described urease inhibiting compounds, nitrification inhibiting compounds, pesticides, herbicides, insecticides, fungicides, and/or miticides in combination with one or more of the described nitrapyrin-monoacid complexes/mixtures. As used herein “pesticide” refers to any agent with pesticidal activity (e.g., herbicides, insecticides, fungicides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, OH), which is hereby incorporated by reference in its entirety.

Exemplary herbicides include, but are not limited to acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp' DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, , vaniliprole, XMC, xylylcarb, zeta cypermethrin and zolaprofos.

Exemplary fungicides include, but are not be limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, Fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, Lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, Phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, Undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the composition of the presently disclosed subject matter is a pesticide/nitrapyrin-containing composition comprising a pesticide and a nitrapyrin-monoacid complex or mixture. In some embodiments, the pesticide is an herbicide, insecticide or a combination thereof.

In some embodiments, the composition of the presently disclosed subject matter is a fungicide/nitrapyrin-containing composition comprising a fungicide and a nitrapyrin-monoacid complex or mixture.

The amount of nitrapyrin-monoacid complex or mixture in the pesticide/nitrapyrin-containing composition and/or fungicide/nitrapyrin-containing composition can vary. In some embodiments, the amount of nitrapyrin-monoacid complex or mixture is present at a level of from about 0.05-10% by weight (more preferably from about 0.1%-4% by weight, and most preferably from about 0.2-2% by weight) based upon the total weight of the pesticide/nitrapyrin-containing composition or fungicide/nitrapyrin-containing composition taken as 100% by weight.

Exemplary classes of miticides include, but are not be limited to botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides - carvacrol, sanguinarine; bridged diphenyl acaricides - azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides - benomyl, carbanolate, carbaryl, carbofuran, methiocarb, metolcarb, promacyl, propoxur; oxime carbamate acaricides -aldicarb, butocarboxim, oxamyl, thiocarboxime, thiofanox; carbazate acaricides - bifenazate; dinitrophenol acaricides - binapacryl, dinex, dinobuton, dinocap, dinocap-4, dinocap-6, dinocton, dinopenton, dinosulfon, dinoterbon, DNOC; formamidine acaricides - amitraz, chlordimeform, chloromebuform, formetanate, formparanate, medimeform, semiamitraz; isoxazoline acaricides - afoxolaner, fluralaner, lotilaner, sarolaner; macrocyclic lactone acaricides - tetranactin; avermectin acaricides - abamectin, doramectin, eprinomectin, ivermectin, selamectin; milbemycin acaricides - milbemectin, milbemycin, oxime, moxidectin; mite growth regulators - clofentezine, cyromazine, diflovidazin, dofenapyn, fluazuron, flubenzimine, flucycloxuron, flufenoxuron, hexythiazox; organochlorine acaricides -bromociclen, camphechlor, DDT, dienochlor, endosulfan, lindane; organophosphate acaricides - chlorfenvinphos, crotoxyphos, dichlorvos, heptenophos, mevinphos, monocrotophos, naled, TEPP, tetrachlorvinphos; organothiophosphate acaricides - amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides - trichlorfon; phosphoramidothioate acaricides - isocarbophos, methamidophos, propetamphos; phosphorodiamide acaricides -dimefox, mipafox, schradan; organotin acaricides - azocyclotin, cyhexatin, fenbutatin, oxide, phostin; phenylsulfamide acaricides - dichlofluanid; phthalimide acaricides - dialifos, phosmet; pyrazole acaricides - cyenopyrafen, fenpyroximate; phenylpyrazole acaricides - acetoprole, fipronil, vaniliprole; pyrazolecarboxamide acaricides - pyflubumide, tebufenpyrad; pyrethroid ester acaricides - acrinathrin, bifenthrin, brofluthrinate, cyhalothrin, cypermethrin, alpha-cypermethrin, fenpropathrin, fenvalerate, flucythrinate, flumethrin, fluvalinate, taufluvalinate, permethrin; pyrethroid ether acaricides - halfenprox; pyrimidinamine acaricides -pyrimidifen; pyrrole acaricides - chlorfenapyr; quaternary ammonium acaricides -sanguinarine; quinoxaline acaricides - chinomethionat, thioquinox; methoxyacrylate strobilurin acaricides - bifujunzhi, fluacrypyrim, flufenoxystrobin, pyriminostrobin; sulfite ester acaricides - aramite, propargite; tetronic acid acaricides - spirodiclofen; tetrazine acaricides, clofentezine, diflovidazin; thiazolidine acaricides - flubenzimine, hexythiazox; thiocarbamate acaricides - fenothiocarb; thiourea acaricides - chloromethiuron, diafenthiuron; unclassified acaricides - acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-m ethyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos + dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide + miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novaluron, oxamyl, oxydemeton- methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids - synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos + dichlorvos, tetradifon, thiamethoxam, thiodicarb, toxaphene, tralomethrin, trimethacarb, and tebufenozide.

### IV. Methods

In some embodiments, the nitrapyrin-monoacid complexes or mixtures are used directly. In other embodiments, the nitrapyrin-monoacid complexes or mixtures are formulated in ways to make their use convenient in the context of productive agriculture. The nitrapyrin-monoacid complexes or mixtrues used in these methods include the nitrapyrin-monoacid complexes or mixtures as described above. The nitrapyrin-monoacid complexes or mixtures can be used in methods such as:
A. Methods of Improving Plant Growth and/or Fertilizing Soil
B. Methods of Inhibiting Nitrification or Ammonia Release or Evolution
C. Methods of Reducing Nitrapyrin Volatilization
D. Methods of Improving Soil Conditions
E. Methods of Preparing Nitrapyrin-Monoacid Complexes

A. Methods for improving plant growth comprise contacting a nitrapyrin-monoacid complex or mixture or a composition containing a nitrapyrin-monoacid complex or mixture as disclosed herein with soil. In some embodiments, the nitrapyrin-monoacid complex or mixture or composition containing a nitrapyrin-monoacid complex or mixture as disclosed herein is applied to the soil prior to emergence of a planted crop. In some embodiments, the nitrapyrin-monoacidcomplex or mixture is applied to the soil adjacent to the plant and/or at the base of the plant and/or in the root zone of the plant.

Methods for improving plant growth can also be achieved by applying a nitrapyrin-monoacid complex or mixture, or a composition containing a nitrapyrin-monoacid complex or mixture as a seed coating to a seed in the form of a liquid dispersion which upon drying forms a dry residue. In these embodiments, seed coating provides the nitrapyrin-monoacid complex or mixture in close proximity to the seed when planted so that the nitrapyrin-monoacid complex or mixture can exert its beneficial effects in the environment where it is most needed. That is, the nitrapyrin-monoacid complex or mixture provides an environment conducive to enhanced plant growth in the area where the effects can be localized around the desired plant. In the case of seeds, the coating containing the nitrapyrin-monoacid complex or mixture provides an enhanced opportunity for seed germination, subsequent plant growth, and an increase in plant nutrient availability.

B. Methods for inhibiting/reducing nitrification or ammonia release or evolution in an affected area comprises applying a nitrapyrin-monoacid complex or mixture or composition containing a nitrapyrin-monoacid complex or mixture to the affected area. The affected area may be soil adjacent to a plant, a field, a pasture, a livestock or poultry confinement facility, pet litter, a manure collection zone, an upright walls forming an enclosure, or a roof substantially covering the area, and in such cases the nitrapyrin-monoacid complex or mixture may be applied directly to the manure in the collection zone. The nitrapyrin-monoacid complex or mixture is preferably applied at a level from about 0.005-3 gallons per ton of manure, in the form of an aqueous dispersion having a pH from about 1-5.

C. Methods of reducing nitrapyrin volatilization comprise complexation or mixing of nitrapyrin with monoacids thereby forming a nitrapyrin-monoacid complex or mixture. Nitrapyrin-monoacid complexes or mixtures are less volatile compared to nitrapyrin that is not complexed or mixed with a monoacid. In some embodiments, the nitrapyrin-monoacid complexes or mixtures reduce volatility by about 5% to about 40%, about 8% to about 35%, about 15% to about 35%, about 25% to about 35%, about 20% to about 30%, or about 10% to about 30% (or by at least about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35%) compared to nitrapyrin that is not complexed or mixed with a monoacid.

D. Methods for improving soil conditions selected from the group consisting of nitrification processes, urease activities, and combinations thereof, comprising the step of applying to soil an effective amount of a described nitrapyrin-monoacid complex or mixture or composition containing a nitrapyrin-monoacid complex or mixture. In some embodiments, the nitrapyrin-monoacid complex or mixture is mixed with an ammoniacal solid, liquid, or gaseous fertilizer, and especially solid fertilizers; in the latter case, the nitrapyrin-monoacid complex or mixture is applied to the surface of the fertilizer as an aqueous dispersion followed by drying, so that the nitrapyrin-monoacid complex or mixture is present on the solid fertilizer as a dried residue. The nitrapyrin-monoacid complex or mixture is generally applied at a level of from about 0.01-10% by weight, based upon the total weight of the nitrapyrin-monoacid complex or mixture /fertilizer product taken as 100% by weight. Where the fertilizer is an aqueous liquid fertilizer, the nitrapyrin-monoacid complex or mixture is added thereto with mixing. The nitrapyrin-monoacid complex or mixutre is preferably in aqueous dispersion and have a pH of up to about 3.

E. Methods of preparing a nitrapyrin-monoacid complexes or mixtures, comprises contacting nitrapyrin with one or more solvents to form a first mixture, contacting the first mixture with a monoacid to form a complex or mixture of nitrapyrin and a monoacid.

In some embodiments, the methods A, B, and D above comprise contacting a desired area with a nitrapyrin-monoacid complex or mixture at a rate of about 100 g to about 120 g per acre of the nitrapyrin-monoacid complex or mixture. The nitrapyrin-monoacid complex or mixture can, in some embodiments, be in solution at an amount of about 0.5 lbs to about 4 lbs per U.S. gallon, or from about 1 lb to about 3 lbs/per U.S. gallon, or about 2 lbs per U.S. gallon. In some embodiments, the method includes contacting the desired area at a rate of about 0.5 to about 4 qt./A, or about 1 to about 2 qt./A.

Particular embodiments of the subject matter described herein include:
1. A nitrapyrin-monoacid complex comprising nitrapyrin complexed with a monoacid.
2. The nitrapyrin-monoacid complex of embodiment 1, wherein the monoacid is selected from a monocarboxylic acid, a monosulfonic acid, and a monophosphonic acid.
3. The nitrapyrin-monoacid complex of embodiment 1, wherein the monoacid is selected from a monocarboxylic acid, a monosulfonic acid, and a monophosphonic acid.
4. A nitrapyrin-monoacid complex comprising nitrapyrin complexed with a monoacid, wherein the monoacid is selected from a monocarboxylic acid, a monosulfonic acid, and a monophosphonic acid.
5. The nitrapyrin-monoacid complex of any above embodiment, wherein the monoacid is substituted with an alkyl group, an alkyenyl group, or an aromatic ring system.
6. The nitrapyrin-monoacid complex of embodiment 5, wherein the aromatic ring system is substituted with one or more of —OR₁, —C(═O)R₂, —PO₃H, —PO₃R₄, —SO₃H, —SO₃R₄, —N(R₃)(R₄), -C₁-C₆ alkyl, halogen, —CN, —CF₃, —NO₂ and —CF₃;
   wherein R₁ is —H, -C₁-C₆ alkyl, or —C(═O)(C₁-C₆ alkyl);
   R₂ is —H, —OH, —N(R₄)(R₄), -C₁-C₆ alkyl, or —O(C₁-C₆ alkyl);
   R₃ is —H, -C₁-C₆ alkyl, or —C(═O)(C₁-C₆ alkyl); and
   R₄ is —H, or -C₁-C₆ alkyl.
7. The nitrapyrin-monoacid complex of embodiment 6, wherein the aromatic ring system is substituted with one or more of —OR₁, —C(═O)R₂ and -C₁-C₆ alkyl;
   wherein R₁ is H, C₁-C₆ alkyl, or —C(═O)(C₁-C₆ alkyl); and
   R₂ is H, —OH, C₁-C₆ alkyl, or —O(C₁-C₆ alkyl).
8. The nitrapyrin-monoacid complex of any one of embodiments 5, 6, and 7, wherein the aromatic ring system is substituted with one or more of —OH, —OCH₃, —C(═O)H, -COOH, —C(═O)CH₃, —C(═O)OCH₃, —OC(═O)CH₃, —CH₃, —NH₂, —NHCH₃, —N(CH₃)₂, and —NC(═O)CH₃.
9. The nitrapyrin-monoacid complex of any one of embodiments 5, 6, 7, and 8, wherein the aromatic ring system comprises one or more heteroatoms selected from N, S and O.
10. The nitrapyrin-monoacid complex of any one of embodiments 5, 6, 7, 8, and 9, wherein the aromatic ring system is an aryl ring system.
11. The nitrapyrin-monoacid complex of embodiment 10, wherein the aryl ring system is a phenyl ring.
12. The nitrapyrin-monoacid complex of any above embodiment, wherein the monoacid is a monocarboxylic acid.
13. The nitrapyrin-monoacid complex of any above embodiment, wherein the monoacid is a compound of Formula (I):

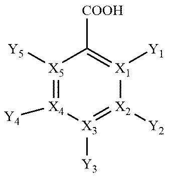

wherein X₁, X₂, X₃, X₄, and X₅ are independently selected from C and N, provided that no more than three of X₁, X₂, X₃, X₄, and X₅ are N, and three N's are not directly adjacent to one another; and Y₁, Y₂, Y₃, Y₄, and Y₅ are independently selected from H, —OR₁, —C(═O)R₂, C₁-C₆ alkyl, —N(R₃)(R₄), and being absent,
wherein R₁ is H, C₁-C₆ alkyl, or —C(═O)(C₁-C₆ alkyl); R₂ is —H, —OH, —N(R₄)(R₄), -C₁-C₆ alkyl, or —O(C₁-C₆ alkyl); R₃ is H, C₁-C₆ alkyl, or —C(═O)(C₁-C₆ alkyl); and R₄ is H or C₁-C₆ alkyl.
14. The nitrapyrin-monoacid complex of embodiment 13, wherein X₁, X₂, X₃, X₄, and X₅ are C.
15. The nitrapyrin-monoacid complex of embodiment 13 or 14, wherein Y₁, Y₂, Y₃, Y₄, and Y₅ are independently selected from H, —OH, —OCH₃, —C(═O)OH, -C₁-C₆ alkyl, and being absent.
16. The nitrapyrin-monoacid complex of any above embodiment, wherein the monoacid is selected from 3,4-dihydrobenzoic acid, 2,4-dihydrobenzoic acid, 2,5-dihydrobenzoic acid, vanillic acid, and 3-4-dimethoxybenzoic acid.
17. The nitrapyrin-monoacid complex of any above embodiment, wherein the monoacid is methanesulfonic acid.
18. The nitrapyrin-monoacid complex of any above embodiment, wherein nitrapyrin and monoacid are present in a weight ratio of from about 5:1 to about 1:5.
19. The nitrapyrin-monoacid complex of any above embodiment, wherein nitrapyrin and monoacid are present in a weight ratio of from about 2.5:1 to about 1:2.5.
20. The nitrapyrin-monoacid complex of any above embodiment, wherein the nitrapyrin-monoacid complex has a lower vapor pressure compared to the vapor pressure of nitrapyrin that is not complexed with a monoacid.
21. A composition comprising the nitrapyrin-monoacid complex of any one of the preceding embodiments and an organic solvent.
22. The composition of embodiment 21, wherein the organic solvent is selected from an aromatic solvent, a halogenated solvent, a glycol-based solvent, a fatty acid-based solvent, an acetate-containing solvent, a ketone-containing solvent, and combinations thereof.
23. The composition of embodiment 21 or 22, wherein the aromatic solvent is an aromatic hydrocarbon and the halogenated solvent is a halogenated aromatic hydrocarbon or a halogenated aliphatic hydrocarbon.
24. The composition of any one of embodiments 21, 22 and 23, wherein the organic solvent is selected from the group consisting of: xylene, propylbenzene, mixed naphthalene and alkyl naphthalene, dimethylsulfoxide, mineral oil, kerosene, dialkyl amide of fatty acid, dimethylamide of fatty acid, dimethyl amide of caprylic acid, 1,1,1-trichloroethane, chlorobenzene, ester of glycol derivative, n-butyl ether of diethyleneglycol, ethyl ether of diethyleneglycol, methyl ether of diethyleneglycol, acetate of the methyl ether of dipropylene glycol, isophorone, trimethylcyclohexanone (dihydroisophorone), acetate, hexyl acetate, heptyl acetate, aromatic 100 (CAS No: 64742-95-6), aromatic 200 (CAS No. 64742-94-5), sulfones, glycols, polyglycol, dipropylene glycol, Dow PT250, Dow PT700, PT250, triethylene glycol, tripropylene glycol, propylene carbonate, triacetin, Agnique® AMD810, Agnique® AMD3L, Rhodiasolv® ADMA10, Rhodiasolv® ADMA810, Rhodiasolv® Polarclean, and mixtures thereof.
25. The composition of embodiment 21, wherein the organic solvent comprises dimethylsulfoxide (DMSO).
26. The composition of embodiment 21, wherein the organic solvent is xylene and dimethylsulfoxide (DMSO).
27. The composition of embodiment 21, wherein the organic solvent is dimethylsulfoxide (DMSO) and Rhodiasolv® Polarclean.
28. The composition of embodiment 21, wherein the organic solvent is Rhodiasolv® Polarclean.
29. The composition of embodiment 21, wherein the organic solvent comprise DMSO, xylene, Rhodiasolv® Polarclean, and a combination thereof.
30. The composition of embodiment 21, wherein the organic solvent is xylene and dimethylsulfoxide (DMSO) and the monoacid is selected from methanesulfonic acid, 2,4-dihydroxybenzoic acid (2,4-DHB acid), 2,5-dihydroxybenzoic acid (2,5-DHB acid), 3,4-dihydroxybenzoic acid (3,4-DHB acid), vanillic acid, and 3,4-dimethoxybenzoic acid.
31. The composition of embodiment 21, wherein the organic solvent is dimethylsulfoxide (DMSO) and Rhodiasolv® Polarclean and the monoacid is selected from 3,4-dihydroxybenzoic acid (3,4-DHB acid), vanillic acid, and 3,4-dimethoxybenzoic acid.
32. The composition of embodiment 21, wherein the organic solvent is Rhodiasolv® Polarclean and the monoacid is selected from 2,4-dihydroxybenzoic acid (2,4-DHB acid) and 2,5-dihydroxybenzoic acid (2,5-DHB acid).
33. The composition of embodiment 21, wherein the organic solvent is present in an amount ranging from about 20% to about 80% w/w based on the total weight of the composition.
34. The composition of embodiment 21, wherein xylene is present in an amount ranging from about 20% to about 80% w/w based on the total weight of the composition.
35. The composition of any above embodiment, wherein the nitrapyrin-monoacid complex is present at a concentration from about 20% to about 50% wt/wt based on the total weight of the composition.
36. The composition of any above embodiment, wherein the nitrapyrin is present at a concentration from about 22% to about 48% wt/wt based on the total weight of the composition.
37. The composition of any above embodiment, wherein the monoacid is present in an amount of from about 10% to about 50% wt/wt based on the total weight of the composition.
38. The composition of any above embodiment, wherein the nitrapyrin is present at a concentration from about 22% to about 48% wt/wt based on the total weight of the composition.
39. The composition of any above embodiment, wherein the composition comprises nitrapyrin in an amount of from about 20% to about 30% w/w, a monoacid in an amount of from about 10% to about 50% w/w, and an organic solvent in an amount of from about 20% to about 60% w/w based on the total weight of the composition.
40. The composition of any above embodiment, wherein the composition comprises nitrapyrin in an amount of from about 20% to about 30% w/w, a monoacid selected from 3,4-DHB acid, 2,4-DHB acid, 2,5-DHB acid, vanillic acid, 3,4-dimethoxybenzoic acid, methanesulfonic acid and any combination thereof present in an amount of from about 10% to about 50% w/w, and an organic solvent selected from xylene, DMSO, Rhodiasolv® Polarclean and any combination thereof present in an amount of from about 20% to about 60% w/w based on the total weight of the composition
41. The composition of any above embodiment, wherein the composition exhibits lower nitrapyrin volatility compared to a nitrapyrin composition wherein the nitrapyrin does not form a complex with a monoacid.
42. An agricultural composition comprising an agricultural product and a nitrapyrin-monoacid complex according to any above embodiment.
43. The agricultural composition of embodiment 42 further comprising an organic solvent.
44. The agricultural composition of embodiment 43, wherein the organic solvent is selected from the group consisting of: xylene, propylbenzene, mixed naphthalene and alkyl naphthalene, dimethylsulfoxide, mineral oil, kerosene, dialkyl amide of fatty acid, dimethylamide of fatty acid, dimethyl amide of caprylic acid, 1,1,1-trichloroethane, chlorobenzene, ester of glycol derivative, n-butyl ether of diethyleneglycol, ethyl ether of diethyleneglycol, methyl ether of diethyleneglycol, acetate of the methyl ether of dipropylene glycol, isophorone, trimethylcyclohexanone (dihydroisophorone), acetate, hexyl acetate, heptyl acetate, aromatic 100 (CAS No: 64742-95-6), aromatic 200 (CAS No. 64742-94-5), sulfones, glycols, polyglycol, dipropylene glycol, Dow PT250, Dow PT700, PT250, triethylene glycol, tripropylene glycol, propylene carbonate, triacetin, Agnique® AMD810, Agnique® AMD3L, Rhodiasolv® ADMA10, Rhodiasolv® ADMA810, Rhodiasolv® Polarclean, and mixtures thereof.
45. The agricultural composition of any one of embodiments 42, 43 and 44, wherein the organic solvent comprises dimethylsulfoxide (DMSO).
46. The agricultural composition of any one of embodiments 42, 43, 44 and 45, wherein the organic solvent is xylene and dimethylsulfoxide (DMSO).
47. The agricultural composition of any one of embodiments 42, 43, 44, and 45, wherein the organic solvent is dimethylsulfoxide (DMSO) and Rhodiasolv® Polarclean.
48. The agricultural composition of any one of embodiments 42, 43, 44, and 45, wherein the organic solvent is Rhodiasolv® Polarclean.
49. The agricultural composition of any one of embodiments 42, 43, 44, and 45, wherein the organic solvent comprises DMSO, xylene, Rhodiasolv® Polarclean, and a combination thereof.
50. The agricultural composition of embodiment 43, wherein the organic solvent is xylene and dimethylsulfoxide (DMSO) and the monoacid is selected from methanesulfonic acid, 2,4-dihydroxybenzoic acid (2,4-DHB acid), 2,5-dihydroxybenzoic acid (2,5-DHB acid), 3,4-dihydroxybenzoic acid (3,4-DHB acid), vanillic acid, and 3,4-dimethoxybenzoic acid.
51. The agricultural composition of embodiment 43, wherein the organic solvent is dimethylsulfoxide (DMSO) and Rhodiasolv® Polarclean and the monoacid is selected from 3,4-dihydroxybenzoic acid (3,4-DHB acid), vanillic acid, and 3,4-dimethoxybenzoic acid.
52. The agricultural composition of embodiment 43, wherein the organic solvent is Rhodiasolv® Polarclean and the monoacid is selected from 2,4-dihydroxybenzoic acid (2,4-DHB acid) and 2,5-dihydroxybenzoic acid (2,5-DHB acid).
53. The agricultural composition of any above embodiment, wherein the agricultural product is selected from the group consisting of a fertilizer, a seed, a urease inhibiting compound, a nitrification inhibiting compound, a pesticide, a herbicide, an insecticide, a fungicide, and a miticide.
54. The agricultural composition any above embodiment, wherein the agricultural product is a fertilizer.
55. The agricultural composition of any above embodiment, wherein the fertilizer is a liquid, solid, granular, fluid suspension, gas, or solutionized fertilizer.
56. The agricultural composition of embodiment 55, wherein nitrapyrin-monoacid complex is applied to the surface of a solid or granular fertilizer in the form of a liquid dispersion coating the solid or granular fertilizer and which after drying is in the form of a dried residue.
57. The agricultural composition of embodiment 55, wherein the fertilizer is in liquid form and the nitrapyrin-monoacid complex is mixed with the liquid fertilizer.
58. The agricultural composition of embodiment 55, wherein the nitrapyrin-monoacid complex is present at a level of about 0.001 to about 20 g per 100 g of the fertilizer; and/or is present at a level of about 0.01-10% w/w based on the total weight of the composition.
59. The agricultural composition of embodiment 55, wherein the fertilizer is selected from the group consisting of: starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing zinc, fertilizers containing manganese, fertilizers containing copper, fertilizers containing molybdenum materials, and mixtures thereof.
60. The agricultural composition of embodiment 59, wherein the fertilizer comprises urea and ammonium nitrate; and/or anhydrous ammonia; and/or is or contains urea; and/or contains one or more of gypsum, Kieserite Group member, potassium product, potassium magnesium sulfate, elemental sulfur, and potassium magnesium sulfate.
61. The agricultural composition of embodiment 53, wherein the seed is coated with the nitrapyrin-monoacid complex according to any above embodiment in the form of an aqueous dispersion to form a coated seed product that after drying thereof provides a level of nitrapyrin from about 0.001-10% by weight, based upon the total weight of the coated seed product.
62. A method of fertilizing soil and/or improving plant growth and/or health comprising contacting a nitrapyrin-monoacid complex according to any above embodiment or a composition according to any above embodiment to the soil.
63. A method of reducing nitrapyrin volatilization by complexing nitrapyrin with a monoacid.
64. The method of embodiment 63, wherein volatilization is reduced by about 10% to about 30% compared to nitrapyrin that is not complexed with a monoacid.
65. A method of reducing atmospheric ammonia and/or nitrification comprising applying a nitrapyrin-monoacid complex according to any above embodiment to an area subject to evolution of ammonia and/or nitrification.
66. A method of reducing atmospheric ammonia and/or nitrification comprising applying a composition according to any above embodiment to an area subject to evolution of ammonia and/or nitrification.

A method of inhibiting a soil condition selected from the group consisting of nitrification processes, urease activities, and combinations thereof, wherein said method comprises applying an effective amount of a nitrapyrin-monoacid complex according to any one above embodiment to the soil.

### EXAMPLES

It should be understood that the following Examples are provided by way of illustration only and nothing therein should be taken as a limiting.

### Example 1: Solubility Studies of Nitrapyrin-Monoacid Complexes and Mixtures in Various Solvent Systems

Nitrapyrin and a monoacid were added to a solvent system containing two different solvents as shown in Tables 1 and 2. The color of resulting solution was recorded as well as the solubility of the nitrapyrin complex in solution. As mentioned already, color changes can occur as the nitrapyrin-monoacid complex forms. The color change is due to complexation; it’s a qualitative indication of complex stability. Generally, this stability is better at lower temperatures since (increase in) thermal energy will destabilize complexation. Staying soluble at lower temps is an indication of disruption of (possible) ordering which implies some formulations will not freeze. The intensity of the color and the color itself depends on the concentration of the monoacid and/or solvent and the choice of monoacid and/or solvent. In particular for monoacids that include a chromophore such as an aromatic ring (see Table 2). Further, the solution was cooled down to lower temperatures to observe the physical properties as is shown in Tables 1 and 2 (see Example 4 for proecedure). No observed freezing of the solutions at lower temperatures of a prolonged time period is a good initial indicator that these solutions can be suitable for cold temperature field applications.

Table 1

| Nitrapyrin* | 2.8 | 2.8 | 2.5 | 2.5 |
|---|---|---|---|---|
| MethaneSulfonicAcid* | 1.17 | | | |
| 3,4-DHB Acid* | | 1.87 | | |
| Vanillic Acid* | | | 1.82 | |
| 3,4-dimethoxybenzoic acid* | | | | 1.97 |
| Polarclean/DMSO*’** | 6.03 | 5.33 | 5.68 | 5.53 |
| Total amount in grams* | 10 | 10 | 10 | 10 |
| Nitrapyrin content | 28% | 28% | 25% | 25% |
| solids content*** | 39.70% | 46.70% | 43.20% | 44.70% |
| Observations | soluble | soluble | soluble | soluble |
| | o/n -20C | 6h, -20C | o/n -20C | o/n -20C |

d/n stands for did not (freeze); o/n stands for overnight (e.g., about 8-14 hours);* Amounts are in grams, to yield a total of 10 grams; ** Rhodiasolv®Polarclean and DMSO are 1:1 by weight;*** Solid content helps in lowering solvent amount.

Table 2

| Nitrapyrin* MethaneSulfonicAcid * | 2.8 1.17 | 2.8 | 2.8 | 2.8 (2.5) | 2.5 (2.8) | 2.5 (2.8) |
|---|---|---|---|---|---|---|
| 2,4-DHB acid* | | 1.87 | | | | |
| 2,5-DHB acid* | | | 1.87 | | | |
| 3,4-DHB acid* | | | | 1.87 (1.67) | | |
| Vanillic Acid* | | | | | 1.82 (2.04) | |
| 3,4-dimethoxybenzoic acid* | | | | | | 1.97 (2.21) |
| xylene/DMSO*'** | 6.03 | 5.33 | 5.33 | 5.33 (5.83) | 5.68(5.16) | 5.53 (4.99) |
| | 10 | 10 | 10 | 10 | 10 | 10 |
| Nitrapyrin content | 28% | 28% | 28% | 28% (25%)^{a} | 25% (28%) ^{a} | 25% (28%) ^{a} |
| Solids content*** | 39.70% | 46.70% | 46.70% | 46.7% (41.7%)^{a} | 43.2% (48.4%)^{a} | 44.7% (50.1%)^{a} |
| Observations | Insoluble | soluble | soluble | barely (soluble) | soluble (both) | soluble |
| | | light pink | light fawn | hazy green | kalamata olive | light fawn |
| | o/n -20C | o/n -20C | o/n -20C | o/n -20C (both) | o/n -20C (both) | o/n -20C |
| | froze | d/n freeze | froze | froze, froze | d/n, d/n | froze |

d/n stands for did not (freeze); o/n stands for overnight (e.g., about 8-14 hours); * Amounts are in grams, to yield a total of 10 grams; ** Xylene and DMSO are 1:1 by weight; ;*** Solid content helps in lowering solvent amount; ^{a}Nitrapyrin/solid content of a second sample.

### Example 2: Volatility Studies of Nitrapyrin-Monoacid Complexes and Mixturers in Various Solvent Systems

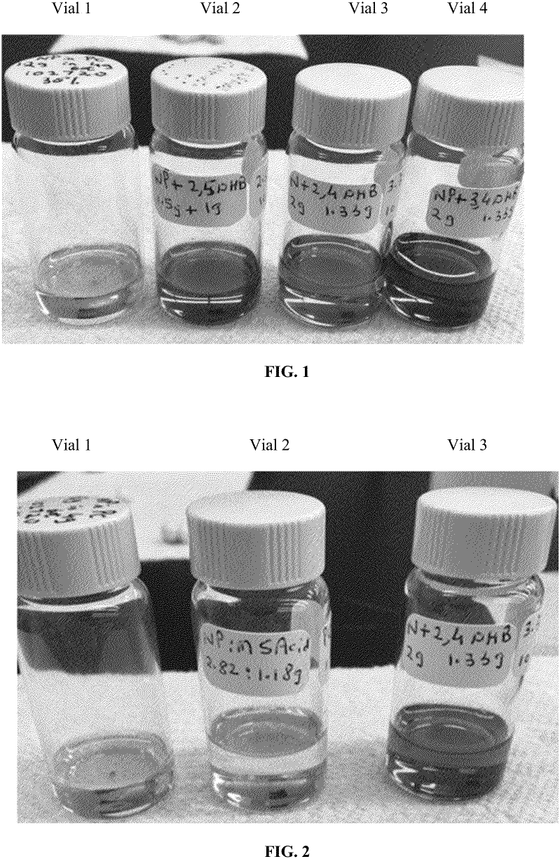

Several solutions were prepared containing nitrapyrin (NP) and monoacid in Rhodiasolv® Polarclean (PC). Nitrapyrin was present at a concentration of 30% w/w based on the total weight of the solution and monoacids 2,4-dihydroxybenzoic acid (2,4-DHBA) and 2,5-dihydroxybenzoic acid (2,5-DHBA) acid were present at 50% w/w (as the final complex) while 3,4-dihydoxybenzoic acid (3,4-DHBA) acid was present at a concentration of 43% w/w (as the final complex) based on the total weight of the solution. All solutions were equimolar in the additive monoacid. Color changes were noted for solutions containing nitrapyrin and the monoacid (due to complex formation) while nitrapyrin by itself was a clear solution (see FIG. 1). Presumably, different colors of the nitrapyrin complex-containing solutions imply unique wavelengths of absorption and can be used as a tool to characterize such complexes.

Solutions were heated at 55° C. for 6 hours and any weight loss was noted as indicated in Table 3 below using ThermoGravimetricAnalysis (TGA; a technique by which one can quantify weight loss accurately).

Table 3

| | | | | | | | |
|---|---|---|---|---|---|---|---|
| Material | SHW L (%) | Material | SHW L (%) | Material | SHW | Material | SHW L (%) |
| PC-NP, Sample 1 | 13.1 | PC-NP-2,5DHBA | 8.9 | PC-NP-2,4-DHBA | 7.4 | PC-NP-3,4DHBA | 10.6 |
| PC -NP, Sample 2 | 14 | PC-NP-2,5DHBA | 9.7 | PC-NP-2,4-DHBA | 9.8 | PC-NP-3,4DHBA | 9.5 |
| PC-NP, Sample 3 | 13 | PC-ND-2,5-DHBA | 10.5 | PC-NP-2,4DHBA | 8 | PC-NP-3,4DHBA | 12.9 |
| PC-NP, Sample 4 | 14.8 | | | | | | |
| PC-NP, Sample 5 | 10.7 | Average = | 9.7 | Average = | 8.7 | Average = | 11 |
| PC-NP, Sample 6 | 14 | | | | | | |
| Average = | 13.3 | 50% solids content | | 50% solids content | | 43% solids content | |
| | | TGA* at 55° C. (131° F.), 6 hrs isothermal | | | | | |
| | | SHWL (%) = Six Hour Weight Loss (%) at 55° C. | | | | | |

* Amount of material used for TGA analysis is 22+3mg.

The above data shows that the average amount of the six hour weight loss for nitrapyrin (NP) in Rhodiasolv® Polarclean (PC) is 13.6%. However, nitrapyrin mixed with isomeric monoacids as shown in table 3 results in a decrease in the amount of the six hour weight loss, presumably due to complexation of the nitrapyrin with the monoacid. More specifically, solutions containing nitrapyrin and 2,4-DHBA only loses 8.7% (~ 35% improvement over nitrapyrin alone); solution containing nitrapyrin and 2,5-DHBA only loses 9.7% (~ 27% improvement over nitrapyrin alone) and 3,4-DHBA complexes only loses 8.7% (~ 17% improvement over nitrapyrin alone). This data shows that addition of monoacids reduces nitrapyrin weight loss. Furthermore, these acids are phenolic and have anti-oxidant properties (which can be used as food preservatives). Depending on geometry, some acids form a stronger complex thereby reducing nitrapyrin weight loss. The above observed TGA mass loss can be used as an indicator of complexation ability of various additives with nitrapyrin.

### Example 3: Volatility Studies of Nitrapyrin Complexes in Various Solvent Systems

Several solutions were prepared containing nitrapyrin (NP) and monoacid in Rhodiasolv® Polarclean (PC). Nitrapyrin was present at a concentration of 30% w/w based on the total weight of the solution and monoacids methylsulfonic acid and 2,4-DHBA were present at 20% w/w (or lower) based on the total weight of the solution. All solutions were equimolar in the additive monoacid. Color changes were noted for solution containing nitrapyrin and monoacid 2,4-DHBA (due to complex formation) while nitrapyrin and methanesulfonic acid remained a clear solution (see FIG. 2) indicating no complex formation.

Solutions were heated at 55° C. for 6 hours. A 12.8% weight loss was noted for methanesulfonic acid, whereas 13.3% weight loss was noted for nitrapyrin. This shows that even mixtures can protect nitrapyin from volatilization although to a lesser extent (about 4%) compared to complexed nitrapyrin based systems.

### Example 4: Solubility Studies of Nitrapyrin Complexes/Mixutres at lower Temperatures

The following step-wise procedure was used to examine the stability and physical properties of various nitrapyrin-monoacid complexes and mixtures:
1) All solvent mixtures were pre-made by mixing 1:1 (by weight) of the 2 solvents and rolled on a bottle roller for 30 minutes (Xy:DMSO and PC:DMSO). Xylene = Xy. Rhodiasolv®PolarClean = PC).
2) Nitrapyrin (NP) solutions were made by adding Nitrapyrin to a glass vial followed by the appropriate amount of solvent mixture and rolling on a bottle roller for 30 minutes (or until homogeneous).
3) Nitrapyrin:mono-acid solutions were made by first adding NP, followed by appropriate stoichiometric amount of the mono-acid, the solvent mixture next and rolling on a bottle roller for 30 minutes (or until homogeneous).
4) All solubilization procedures were done at ambient temperature (on a bottle roller).
5) The freeze-thaw procedures were conducted by placing the appropriate vial in freezer (-24° C.) for 1 hour (freeze), setting on a work bench for 1 hour (thaw) and doing this 3 times (for a total time of little over 6 hours). Observations were made hourly. 6 observations total.
6) Observation 1 means status of material was observed after first freeze (-24° C.) and first thaw. Hence, two observations. Same for Observations 2 (second freeze/thaw) and 3 (third freeze/thaw).
7) NP was dissolved in both solvent mixtures at 28% (by weight). Total amount of material used for every vial (first column, below) was 7.5 g. Vial size was 20 mL capacity.

The results of the above study if shown in Table 4 below.

Table 4

| Material | Observation 1 | Observation 2 | Observation 3 |
|---|---|---|---|
| PC:DMSO | Froze, homogeneous | Froze, homogeneous | Froze, homogeneous |
| Xy:DMSO | Froze, homogeneous | Froze, homogeneous | Froze, homogeneous |
| NP in PC:DMSO | Froze, homogeneous | Froze, homogeneous | Froze, homogeneous |
| NP in Xy:DMSO | Froze, homogeneous | Froze, homogeneous | Froze, homogeneous |

Conclusions of Examples 1-4:
NP and various monoacid complexes form homogeneous and clear solutions at ambient temperatures; depending on the structural features of the monoacid, some solutions can be colored due to the formation of complexes.
Table 2 shows that the NP:2,4-DHB acid complex and the NP:Vanillic acid complex (in Xy:DMSO) did not freeze (overnight at -20° C.) despite Xy:DMSO as well as NP in Xy:DMSO freezes (as seen above in Table 4).
Based on the data from these tables, it is clear that NP-monoacid complexes impart better solubility at lower temperatures while reducing volatility of the NP; thus increasing NUE (nutrient use efficiency).

All technical and scientific terms used herein have the same meaning. Efforts have been made to ensure accuracy with respect to numbers used (e.g., amounts, temperature, etc.), but some experimental errors and deviations should be accounted for.

Throughout this specification and the claims, the words “comprise,” “comprises,” and “comprising” are used in a nonexclusive sense, except where the context requires otherwise. It is understood that embodiments described herein include “consisting of” and/or “consisting essentially of” embodiments.

As used herein, the term “about,” when referring to a value is meant to encompass variations of, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A nitrapyrin-monoacid complex comprising nitrapyrin complexed with a monoacid, wherein the monoacid is selected from a monocarboxylic acid, a monosulfonic acid, and a monophosphonic acid, wherein the monoacid is substituted with an alkyl group, an alkyenyl group, or an aromatic ring system.

2. (canceled)

3. The nitrapyrin-monoacid complex of claim 1, wherein the aromatic ring system is substituted with one or more of —OR₁, —C(═O)R₂, —PO₃H, —PO₃R₄, —SO₃H, —SO₃R₄, —N(R₃)(R₄), -C₁-C₆ alkyl, halogen, —CN, —CF₃, —NO₂ and —CF₃;
wherein R₁ is —H, -C₁-C₆ alkyl, or —C(═O)(C₁-C₆ alkyl);
R₂ is —H, —OH, —N(R₄)(R₄), -C₁-C₆ alkyl, or —O(C₁-C₆ alkyl);
R₃ is —H, -C₁-C₆ alkyl, or —C(═O)(C₁-C₆ alkyl); and
R₄ is —H, or -C₁-C₆ alkyl.

4. (canceled)

5. (canceled)

6. The nitrapyrin-monoacid complex of claim 1, wherein the monoacid is a compound of Formula (I): 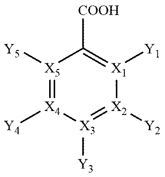
wherein X₁, X₂, X₃, X₄, and X₅ are independently selected from C and N, provided that no more than three of X₁, X₂, X₃, X₄, and X₅ are N, and three N's are not directly adjacent to one another; and Y₁, Y₂, Y₃, Y₄, and Y₅ are independently selected from H, —OR₁, —C(═O)R₂, C₁-C₆ alkyl, —N(R₃)(R₄), and being absent,
wherein R₁ is H, C₁-C₆ alkyl, or —C(═O)(C₁-C₆ alkyl);
R₂ is —H, —OH, —N(R₄)(R₄), -C₁-C₆ alkyl, or —O(C₁-C₆ alkyl);
R₃ is H, C₁-C₆ alkyl, or —C(═O)(C₁-C₆ alkyl); and
R₄ is H or C₁-C₆ alkyl.

7. The nitrapyrin-monoacid complex of claim 6, wherein X₁, X₂, X₃, X₄, and X₅ are C; and/or Y₁, Y₂, Y₃, Y₄, and Y₅ are independently selected from H, —OH, —OCH₃, —C(═O)OH, -C₁-C₆ alkyl, and being absent.

8. (canceled)

9. The nitrapyrin-monoacid complex of claim 1, wherein the nitrapyrin-monoacid complex has a lower vapor pressure compared to the vapor pressure of a nitrapyrin that is not complexed with a monoacid.

10. The nitrapyrin-monoacid complex of claim 1, wherein the monoacid is selected from 3,4-dihydroxybenzoic acid (3,4-DHB acid), 2,4-dihydroxybenzoic acid (2,4-DHB acid), 2,5-dihydroxybenzoic acid (2,5-DHB acid), Vanillic Acid, and 3,4-dimethoxybenzoic acid (3,4-DHB acid).

11. The nitrapyrin-monoacid complex of claim 1, wherein nitrapyrin and monoacid are present in a weight ratio of from about 5:1 to about 1:5.

12. A composition comprising the nitrapyrin-monoacid complex of claim 1 and an organic solvent.

13. The composition of claim 12, wherein the organic solvent is selected from the group consisting of: xylene, propylbenzene, mixed naphthalene and alkyl naphthalene, dimethylsulfoxide, mineral oil, kerosene, dialkyl amide of fatty acid, dimethylamide of fatty acid, dimethyl amide of caprylic acid, 1,1,1-trichloroethane, chlorobenzene, ester of glycol derivative, n-butyl ether of diethyleneglycol, ethyl ether of diethyleneglycol, methyl ether of diethyleneglycol, acetate of the methyl ether of dipropylene glycol, isophorone, trimethylcyclohexanone (dihydroisophorone), acetate, hexyl acetate, heptyl acetate, aromatic 100 (CAS No: 64742-95-6), aromatic 200 (CAS No. 64742-94-5), sulfones, glycols, polyglycol, dipropylene glycol, Dow PT250, Dow PT700, PT250, triethylene glycol, tripropylene glycol, propylene carbonate, triacetin, Agnique® AMD 810, Agnique® AMD 3L, Rhodiasolv® ADMA 10, Rhodiasolv® ADMA 810, Rhodiasolv® Polarclean, and mixtures thereof.

14. (canceled)

15. The composition of claim 12, wherein the organic solvent is xylene and dimethylsulfoxide (DMSO) and the monoacid is selected from methanesulfonic acid, 2,4-dihydroxybenzoic acid (2,4-DHB acid), 2,5-dihydroxybenzoic acid (2,5-DHB acid), 3,4-dihydroxybenzoic acid (3,4-DHB acid), vanillic acid, and 3,4-dimethoxybenzoic acid.

16. The composition of claim 12, wherein the organic solvent is dimethylsulfoxide (DMSO) and Rhodiasolv® Polarclean and the monoacid is selected from 3,4-dihydroxybenzoic acid (3,4-DHB acid), vanillic acid, and 3,4-dimethoxybenzoic acid.

17. The composition of claim 12, wherein the organic solvent is Rhodiasolv® Polarclean and the monoacid is selected from 2,4-dihydroxybenzoic acid (2,4-DHB acid) and 2,5-dihydroxybenzoic acid (2,5-DHB acid).

18. The composition of claim 12, wherein the organic solvent is present in an amount of from about 20% to about 80% w/w based on the total weight of the composition.

19. The composition of claim 12, wherein nitrapyrin is present in an amount of from about 22% to about 48% w/w based on the total weight of the composition.

20. The composition of claim 12, wherein the monoacid is present in an amount of from about 10% to about 50% w/w based on the total weight of the composition.

21. (canceled)

22. (canceled)

23. The composition of claim 12, wherein the composition comprises nitrapyrin in an amount of from about 20% to about 30% w/w, a monoacid selected from 3,4-DHB acid, 2,4-DHB acid, 2,5-DHB acid, vanillic acid, 3,4-dimethoxybenzoic acid, methanesulfonic acid and any combination thereof present in an amount of from about 10% to about 50% w/w, and an organic solvent selected from xylene, DMSO, Rhodiasolv® Polarclean and any combination thereof present in an amount of from about 20% to about 60% w/w based on the total weight of the composition.

24. (canceled)

25. An agricultural composition comprising an agricultural product and a nitrapyrin-monoacid complex according to claim 1, wherein the agricultural product is selected from the group consisting of a fertilizer, a seed, an urease inhibiting compound, a nitrification inhibiting compound, a pesticide, a herbicide, an insecticide, a fungicide, and a miticide.

26. (canceled)

27. The agricultural composition of claim 25 wherein the agricultural product is a fertilizer, wherein the fertilizer is a liquid, solid, granular, fluid suspension, gas, or solutionized fertilizer.

28. (canceled)

29. The agricultural composition of claim 27, wherein the nitrapyrin-monoacid complex is present at a level of about 0.001 to about 20 g per 100 g of the fertilizer; and/or is present at a level of about 0.01-10% w/w based on the total weight of the composition.

30. (canceled)

31. (canceled)

32. The agricultural composition of claim 25, wherein the seed is coated with the nitrapyrin-monoacid complex according to claim 1 in the form of an aqueous dispersion to form a coated seed product that after drying thereof provides a level of nitrapyrin from about 0.001-10% by weight, based upon the total weight of the coated seed product.

33. (canceled)

34. (canceled)

35. (canceled)

36. (canceled)

37. (canceled)

38. (canceled)
